(19) United States
(12) Patent Application Publication
(10) Pub. No.: US 2013/0181460 A1
(43) Pub. Date: Jul. 18, 2013

(54) Zero carbon energy from hydrocarbon fuels and sunlight

(71) Applicant: ClearValue Technologies, Inc., Missouri City, TX (US)

(72) Inventors: Richard Alan Haase, Missouri City, TX (US); Fashil Salih, Spring, TX (US)

(73) Assignee: ClearValue Technologies, Inc., Missouri City, TX (US)

(21) Appl. No.: 13/815,217

(22) Filed: Feb. 11, 2013

Related U.S. Application Data
(63) Continuation-in-part of application No. PCT/US12/01415, filed on Aug. 11, 2011.

(51) Int. Cl. F03D 9/00; H02K 7/18

(52) U.S. Cl. CPC F03D 9/002; H02K 7/1807
USPC 290/1 R; 290/55; 60/772

(57) ABSTRACT

The instant invention comprises improved Means for the creation of electrical energy, mechanical energy, H₂, O₂ and other useful products; wherein, there is minimal to no release of CO_{X}, NO_{X} or SO_{X}. The instant invention comprises Reforming and Sunlight to create H₂; wherein CO₂ from Reforming is converted to O₂ in a 3d PBR; and wherein, Sunlight is converted into electrical energy and/or H₂ and O₂. The instant invention comprises Means for production of at least one of H₂ and O₂ from Sunlight; wherein, use of Sunlight is significantly and unexpectedly improved. The instant invention separates Sunlight into two wavelength portions, that which is Infrared and that which is Visible; wherein, Infrared heats an Aqueous Solution to produce electricity from steam; and wherein, Visible produces electricity via PV and/or is supplied to the 3d PBR. The instant invention relates to improved methods for combustion of H₂ and O₂.

### RELATED APPLICATION DATA

This application claims priority on U.S. Provisional Application 61/401,344 filed Aug. 11, 2010 and PCT/US2011/001415 filed Aug. 11, 2011.

### BACKGROUND OF THE INVENTION

### Field of the Invention

The instant invention comprises improved Means (the instant invention defines Means as “at least one of a method, system, process and apparatus”) for energy, the creation of electrical energy, the creation of mechanical energy, the creation of hydrogen (“H₂”), the creation of a pure oxygen (“O₂”—the instant invention defines pure O₂ as “a gas or liquid comprising O₂ wherein the concentration of O₂ is greater than about 90%”) and of the creation of useful products therein; wherein, there is minimal to no release of at least one of: oxides of carbon (“CO_{X}”), oxides of nitrogen (“NO_{X}”) and oxides of sulfur (“SO_{X}”). The instant invention comprises Reforming (the instant invention defines Reforming as the hydrocarbon reformation of a hydrocarbon, most preferably methane (“CH₄”) into H₂ and CO₂) and/or Sunlight (“Light Energy”) to create H₂; wherein the CO₂ from Reforming is converted to O₂ via micro-organisms, plants or algae; and wherein, Sunlight is converted into electrical energy and/or H₂ and O₂.

The instant invention comprises Means for the production of at least one of H₂ and O₂ from Light Energy (within the instant invention, Light Energy is defined as “any wavelength in the light spectrum from about 1×10⁻⁸ meter to about 4×10⁻⁶ meter”. Within Means of the instant invention, use of Light Energy is significantly and unexpectedly improved. Within Means, H₂ and O₂ are produced; wherein, use of Light Energy to produce H₂ and O₂ is significantly and unexpectedly improved. Within Means, Light Energy is separated into two wavelength portions, that which is Infrared (the instant invention defines Infrared to comprise any wavelength of Light Energy of greater than about 1×10⁻⁶ meter) and that which is Visible Zero Carbon Energy From Hydrocarbon Fuels and Sunlight EG 530958783 US (the instant invention defines Visible to comprise any wavelength of Light Energy from about 1×10⁻⁸ meter to about 1×10⁻⁶ meter). Means comprises at least a portion of Infrared to heat at least a portion of an Aqueous Solution (within the instant invention, Aqueous Solution is defined as “any liquid that comprises water (“H₂O”) and at least one Electrolyte with an Electrolyte defined to comprise any cation and anion pair) and at least a portion of Visible to produce electricity; wherein, it is preferred that at least a portion of the electricity performs electrolysis of at least a portion of the Aqueous Solution into H₂ and O₂.

The instant invention relates to improved methods for the combustion of H₂ and O₂; wherein the H₂ is obtained from Reforming or Light Energy and O₂ is obtained from conversion of carbon dioxide (CO₂) by micro-organisms, plants or algae, by said electrolysis of H₂O and separation of air. The instant invention is based upon the chemistry of H₂O.

The discovered instant invention surprisingly comprises significantly improved economics in the use of hydrocarbons and Light Energy as energy sources. The discovered instant invention surprisingly comprises minimal to no release of CO_{X}, NO_{X} or SO_{X}. The discovered instant invention surprisingly comprises a Means of food and/or nutrient source. The discovered instant invention surprisingly comprises at least one solution to both transportation and power energy needs with improved efficiency and economics. This discovered instant invention surprisingly comprises significant improvement in efficiency of conversion of Light Energy into electricity.

The discovered instant invention relates to generating electricity (electrical energy). Four Means of generating electricity are discovered. The first places a steam turbine in the exhaust of a hydrogen engine of the instant invention; wherein, said steam turbine is driven by steam produced in combustion; and wherein, said steam turbine turns a Generator (within the instant invention, Generator is defined as “any electro-mechanical device that converts mechanical energy into electrical energy and further comprises the traditionally known generator to create an alternating current, an alternator to create a direct current and the traditional generator/rectifier combination to create a direct current”); and wherein at least a portion of said steam energy is converted into said electricity. The second comprises a Generator to receive rotating mechanical energy of a combustion engine of the instant invention. The third obtains electricity from photovoltaic conversion of Visible. And the fourth obtains electricity from steam energy produced by Infrared in contact with an Aqueous solution; wherein the H₂O is converted into seam energy; and, the steam energy turns a steam turbine which turns a Generator.

Finally, the instant invention relates to applications of producing mechanical and/or electrical energy; wherein, there is minimal to no release of CO_{X}, NO_{X} or SO_{X}.

The discovered instant invention relates to improved Means to convert CO_{X}, NO_{X} and SO_{X} within an algae photo-bio-reactor (“PBR”). Previous attempts are of a two (2) dimensional (“2d”) nature; such that, algae growth is limited to the surface of a water, such as a pond or raceway. In improved contrast, the instant invention comprises a three (3) d PBR that is enclosed; wherein, light is brought to the 3d PBR; such that, algae grow throughout a water column.

The discovered instant invention relates to improved Means of energy from Light Energy; such that, the Infrared and Visible portions of the light spectrum are separated; wherein, the Infrared portion transfers its energy to an Aqueous Solution; and wherein, the Visible portion transfers its energy to at least one of the 3d PBR and PV.

The instant invention defines “Natural Conversion” as “the conversion of at least one of: CO_{X} to Living Matter and O₂, NO_{X} to nitrogen (“N₂”), and SO_{X} to elemental sulfur (“S”) or S within living matter; wherein, conversion is performed by at least one of an algae, a bacteria and a plant; wherein “Living Matter” is defined as at least one of: an algae, a bacteria and a plant”. The most preferred Means of Natural Conversion is via a PBR.

The instant invention defines a “Hydrocarbon” as “any chemical moiety comprising carbon (“C”) and hydrogen (“H”) which may comprise oxygen (“O”), sulfur (“S”) or nitrogen (“N”).

The instant invention defines “Methane Reforming” as “the conversion of CH₄ to H₂ and CO incorporating H₂O and the subsequent conversion of CO and H₂O to H₂ and CO₂”. The instant invention defines “Hydrocarbon Reforming” as “the conversion of a Hydrocarbon to H₂ and CO incorporating H₂O and the subsequent conversion of CO and H₂O to H₂ and CO₂”. The instant invention further defines a “Reforming” to comprise Methane and Hydrocarbon Reforming, as known in the art and used herein.

Often times, Hydrocarbon cracking is used in combination with Methane Reforming; the instant invention, when referring to Reforming comprises Hydrocarbon cracking in combination with Methane Reforming, as is known in the art.

The “Water Gas Shift Reaction”, as is known in the art, converts CO and H₂O to H₂ and CO₂; the instant invention incorporates the Water Gas Shift Reaction, as is known in the art, as a portion of Methane Reforming and of Hydrocarbon Reforming.

The instant invention defines a “PBR” as a photo-bio-reactor, and a photo-bio-reactor as any reactor comprising at least one strain of algae wherein at least a portion of Light Energy converts an oxide of carbon into O₂ and bio-mass.

The instant invention defines “Photo-toxicity” as “a concentration of light in Aqueous Solution which inhibits growth of algae”.

The instant invention defines a “Hydrogen Engine” as “an engine combusting H₂ with O₂ in the presence of H₂O; wherein, N₂ is at a concentration of less than 50 percent in the Combustion Chamber; and wherein, the engine can be either of piston or turbine design”.

The instant invention defines a “Combustion Chamber” as “a volume wherein combustion takes place or wherein the energy and/or products of combustion create at least one selected from the list of: energy, power, torque and any combination therein”.

The instant invention defines “Transportation” as “any Means for the transfer of a good or a person, including but not limited to: automobiles, trucks, buses, boats, trains and airplanes”.

The instant invention defines an Internal Combustion Engine (“ICE”) as an engine comprising at least one piston and/or cylinder.

The instant invention defines “Transportation” as the movement of goods or people. Transportation comprises cars, trucks, buses, boats, trains and airplanes.

### Background of the Invention

Humanity has, over the centuries, developed many forms of energy, along with many forms of Transportation. In the modern economy, energy is needed to literally “fuel” the economy. Energy heats homes, factories and offices, provides electrical power, powers manufacturing facilities, and provides for the Transportation of goods and people. During the 19'th and 20'th centuries, mankind developed fossil fuels into reliable and inexpensive energy sources. Today, fossil fuels are used in Transportation, manufacturing, electricity generation and heating. Use caused fossil fuel combustion products to be a major source of air and H₂O pollution.

Hydrocarbon Energy—Fossil fuels (Hydrocarbons) are used as a fuel along with air as an oxidant to generate combustion energy. Hydrocarbons are either: petroleum distillates such as gasoline, diesel, fuel oil, jet fuel and kerosene; fermentation distillates such as methanol and ethanol; or natural products such as methane, ethane, propane, butane, coal and wood. However, excess hydrocarbon combustion interferes with nature. The products of hydrocarbon combustion were thought to work in concert with nature's O₂-carbon cycle, wherein CO₂ is recycled by plant life photosynthesis back into O₂. However, excess CO₂, e.g. excess combustion, upsets the environment. The combustion of a hydrocarbon can be approximated by:

CₙH₂ₙ₊₂+(3/2n+½)O₂→nCO₂+(n+1)H₂O+Energy

And, for natural gas (methane):

CH₄+3O₂→CO₂+2H₂O+213 kcal

COx is produced by the combustion of fossil fuels. It is generally known that global warming and climate change is a result of a buildup of CO_{X} and CH₄ in the Earth's atmosphere; wherein, CH₄ comprises near 20+ times the global warming and therefore climate change affect of CO₂. Natural Conversion recycles CO₂ back into O₂; however, man-made production of CO₂ in combination with significant deforestation have left Earth's algal, microbiological and plant life incapable of converting enough of manmade CO₂ back into O₂, thereby causing a buildup of CO₂ in Earth's atmosphere. This is while CO, an incomplete combustion by-product, is toxic to all human, animal and plant life.

In addition, hydrocarbon combustion with air creates NO_{X} which retards photosynthesis, while being toxic to all human, animal and plant life. Formation of NO_{X} is endothermic, thereby lessening combustion efficiency. Once formed, NO_{X} further reacts with O₂ in the air to form ozone (“O₃”). O₃ is toxic to all human, animal and plant life. O₃, in the upper atmosphere, does protect life on Earth from harmful UN radiation; however, at the surface, O₃ is toxic to all life.

Liquid and solid hydrocarbons naturally contain sulfur (“S”) as a contaminant. In combustion, S is oxidized to SO_{X} which is also toxic to all human, animal and plant life.

Lastly, CO_{X}, NO_{X} and SO_{X} react with H₂O in the air (humidity and rain) to form acids, e.g. H₂CO₃, HNO₃, HSO₃ and H₂SO₄ which then literally rain acids upon the Earth.

Hydrocarbon fuels have been modified with additives to minimize formation of either COx or NOx. However, with all of the scrubber modifications, engine modifications and fuel modifications, photosynthesis by Earth's plant life cannot keep up. In addition to environmental issues, a growing world population has made availability and dependability of large quantities of petroleum hydrocarbons a geopolitical issue.

Sunlight Energy—A major source of energy is Sunlight. The Earth receives about 7000 times more energy in Sunlight than is needed to fuel the world economy. The Earth receives about 174,000 TeraWatt of Sunlight annually; while, in 2020 humanity is estimated to need about 20 TeraWatt to fuel the world economy. Therefore, in recent years, much effort and investment has been placed in production of electricity from Sunlight. One significant effort is in solar cells, which are otherwise known as photovoltaic (“PV”) conversion of Sunlight to electricity; wherein, PV incorporates Visible to convert photon energy into electricity (within the instant invention, PV is defined as “any electro-chemical Means to convert Visible into electricity and/or any Means comprising conversion of photons from within Visible into an electrical current”). However, efficiency of PV is limited; while, Infrared heats PV cells thereby reducing an already limited PV efficiency. A second significant effort is in production of steam from Sunlight; wherein, the steam is used to turn a steam turbine and the steam turbine turns a generator or alternator to generate electricity.

Prior to the instant invention, previous work in the Water Combustion Technology (WCT) and the Haase Cycle is referenced herein in U.S application Ser. No. 10/790,316, PCT/US 03/11250, PCT/US 03/41719 and PCT/US06/048057, along with references therein.

Prior to the instant invention, previous work to develop a natural solution to production of at least one of CO_{N}, NO_{X} and SO_{X} is referenced herein in U.S. application Ser. No. 12/231,992, U.S. application Ser. No. 12,660,945 and PCT/US08/10495, along with references therein.

### SUMMARY OF THE INVENTION

A primary object of the instant invention is to devise effective, efficient and economically feasible Means to produce electricity and/or H₂ from CH₄ and/or Light Energy.

Another object of the invention is to devise effective, efficient and economically feasible Means to produce electricity and/or H₂ from a Hydrocarbon and/or Light Energy.

Still another object of the instant invention is to devise effective, efficient and economically feasible Means to produce electricity and/or H₂ from CH₄; wherein, there is minimal release of CO_{X}, NO_{X} or SO_{X}.

Further, another object of the instant invention is to devise effective, efficient and economically feasible Means to produce electricity and/or H₂ from a Hydrocarbon; wherein, there is minimal release of CO_{X}, NO_{X} or SO_{X}.

Further still, another object of the instant invention is to devise effective, efficient and economically feasible Means to produce H₂ from CH₄; wherein, there is minimal or no release of CO_{X}, NO_{X} or SO_{X}; and wherein, there is an effective transportation Means for the H₂.

Still further, another object of the instant invention is to devise effective, efficient and economically feasible Means to produce H₂ from a Hydrocarbon; wherein, there is minimal or no release of CO_{X}, NO_{X} or SO_{X}; and wherein, there is an effective transportation Means for the H₂.

Still further yet, another object of the instant invention is to devise effective, efficient and economically feasible Means to produce at least one of electricity and H₂ from a Hydrocarbon; wherein, there is minimal or no release of CO_{X}, NO_{X} or SO_{X}; wherein, there is the H₂ is used in Transportation; and wherein, the Means is not just environmentally viable, the Means is economically attractive.

Still yet further, an object of the instant invention is to devise environmentally friendly, effective, efficient and economically feasible Means to produce a clean fuel from Sunlight and/or Light Energy.

Also still yet further, an object of the instant invention is to devise environmentally friendly, effective, efficient and economically feasible Means to separate Sunlight and/or Light Energy into Infrared and Visible.

Still also yet further, an object of the instant invention is to devise environmentally friendly, effective, efficient and economically feasible Means to produce H₂ from Sunlight and/or Light Energy.

Still yet also further, another object of the instant invention is to devise environmentally friendly, effective, efficient and economically feasible Means to produce H₂ from a combination of Infrared and Visible in Sunlight and/or Light Energy.

Still yet further also, another object of the instant invention is to devise environmentally friendly, effective, efficient and economically feasible Means to produce H₂ from Sunlight and/or Light Energy, along with environmentally friendly, effective, efficient and economically feasible Application Means of the H₂.

Also, an object of the instant invention is to devise environmentally friendly, effective, efficient and economically feasible Means to separate Sunlight and/or Light Energy into Infrared and Visible; wherein, Infrared and Visible are used to produce H₂, along with environmentally friendly, effective, efficient and economically feasible Application Means of the H₂.

Finally, an object of the instant invention is to provide economical means to produce at least one of electricity, H₂ and a heat sink for refrigeration and/or air conditioning.

The instant invention has surprisingly been found to be economically attractive; therein, providing economical and business incentive for application of the instant invention. As, if Humanity has a Means to economically produce at least one of clean electricity, fuel and refrigeration, there would exist economical and business incentive; within which, there would be a greater propensity for Humanity to incorporate and therein combat Humanity's harm upon Earth.

Additional objects and advantages of the invention will be set forth in part in a description which follows and in part will be obvious from the description, or may be learned by practice of the invention.

The instant invention answers a long felt need of Humanity.

### BRIEF DESCRIPTION OF THE DRAWINGS

A better understanding of the present invention can be obtained when the following descriptions of the preferred embodiments are considered in conjunction with the following drawings, in which:

FIGS. 1 and 1.1 illustrates a legend for FIGS. 2 through 18.

FIG. 2 illustrates a graphical representation of the production of H₂ from Reformer [1]; wherein, endothermic requirement of the Reformer is at least partially provided by at least one of: a windmill in combination with a rectifier and a resistance heater [2], collected Sunlight wherein the Infrared energy is transferred to the Reformer via H₂O [3], and combustion of H₂ [4]; wherein, the H₂ from Reforming is combusted as fuel in a combustion/steam turbine engine [5] to produce electricity; wherein, Natural Conversion in a PBR [6] takes CO₂ from the Reformer to produce O₂; wherein, the O₂ is an oxidizer for the Hydrogen Engine/steam turbine/Generator combination to make electricity; and wherein, a Hydrogen Engine [7] also uses the H₂ as fuel.

FIG. 3 illustrates a graphical representation of the instant Hydrogen Engine/steam turbine/Generator combination; wherein H₂ from Reforming is burned in a Combustion Chamber and/or turbine [8] with O₂ from Natural Conversion and/or Electrolysis of H₂O and/or separation of air in the presence of H₂O; wherein, the steam exhaust from at least one of the Combustion Chamber and turbine enters a number of steam turbines with the first of highest pressure and the last of lowest pressure [9]; wherein, at least one of the combustion turbine(s) and the steam turbine(s) create rotating mechanical energy [10]; such that, a Generator is turned by the rotating mechanical energy to create electricity [11].

FIG. 4 illustrates in block diagram form a preferred embodiment of the instant invention as the instant invention as it applies to ICE; wherein, H₂ from H₂ Storage [24] and O₂ from at least one of Electrolysis [22] and Cryogenic Distillation [23] are provided via transfer lines [12] to a Combustion Chamber [13] comprising a piston [14] which transfers combustion energy to a driveshaft [14.1], therein creating rotating mechanical energy; wherein engine exhaust leaves the Combustion Chamber [13] via at least one exhaust line [16]; wherein at least one exhaust line comprises pressure release [15 and 20] and energy recycle; wherein energy recycle comprises a steam turbine/Generator/Converter [18] that provides electrical energy to an electrolysis cell [22]; wherein at least one of steam and condensate from the steam turbine [18] flows to a condenser [21], after which at least a portion of the condensate flows to electrolysis [22] and at least a portion flows to the Combustion Chamber [13] via pump [19]; wherein, air is cryogenically distilled into O₂ and N₂ [23]; wherein, the Cryogenic Distillation of Air [23] is at least partially powered by the driveshaft [14.1], therein using at least a portion of the rotating mechanical energy; wherein the O₂ which is transferred to the Combustion Chamber [13] via transfer lines [12]; wherein, the cryogenic N₂ flows to H₂ storage to cool the stored H₂; wherein H₂ is obtained from at least one of Reforming and Electrolysis of H₂O; and wherein alternatively O₂ is supplied in air via compressor [12] that is also at least partially powered by the driveshaft [14.1].

FIG. 5 illustrates a graphical representation of a preferred embodiment of the instant invention as the instant invention applies to a PBR; wherein, Light Energy (usually Sunlight) is collected via a Collector [29] and transferred to the 3d PBR [27] via transfer line [30]; wherein, heat is removed from the Light Energy via heat exchanger [31] prior to distribution [28] into the 3d PBR [27]; wherein, CO₂ from Reforming is absorbed into aqueous solution [26] in the 3d PBR [27]; wherein, pressure is managed within the 3d PBR [32]; wherein, the 3d PBR [27] converts the CO₂ into O₂ and Living Matter via Natural Conversion; wherein, the aqueous phase is separated with separation Means, as is known in the art [33]; and wherein, at least a portion of the created O₂ within the 3d PBR [27] is captured and transferred to a Hydrogen Engine.

FIG. 6 illustrates a graphical representation of a preferred embodiment of the instant invention as the instant invention applies to Reforming; wherein, energy is provided to Reforming [37] via at least one of: Reforming [38], Light Energy collected via Collector [29] which is transferred to heat exchanger [31] such that steam is created from Infrared [3], wind turns a windmill [34] which provides rotating mechanical energy to either a Generator [35] or an alternator with a rectifier [36] that sends electrical energy to a Resistance Heater [2], and a Combustion Heater which at least partially burns H₂ from Reformers [37] or [38] and/or burns CH₄; wherein, Reformer [37] converts C_{X}H_{Y} and AH₂O into XCO and [(Y+2A)/2]H₂; wherein Reformer [38] converts XCO and BH₂O into XCO₂ and BH₂; wherein, [(Y+2A)/2]H₂+BH₂=DH₂; wherein, at least a portion of the DH₂ is used in at least one of: power generation and Transportation via at least one Hydrogen Engine; and wherein, the XCO₂ flows to the 3d PBR.

FIG. 7 illustrates a graphical representation of H₂ and O₂ combustor [8] Means to produce steam, wherein H₂O is not added to the Combustion Chamber [40] to reduce Combustion Chamber temperature.

FIG. 8 illustrates a graphical representation of H₂ and O₂ combustor [8] Means to produce steam, wherein the Combustion Chamber [40] comprises H₂O to reduce Combustion Chamber temperature.

FIG. 9 illustrates a graphical representation of a flow diagram to produce at least one of H₂ and O₂ from H₂O and Light Energy; wherein, electrolyte flow is controlled via control valve [56] which receives a flow control signal from controller [55] that creates the flow control signal from a calculated deviation from a desired set-point that is compared to conductivity of the water as measured by sensor [54]; wherein, Aqueous Solution, comprising H₂O and electrolyte, flows via pipe [53] to Light Energy Reaction Chamber [52] that preferably comprises a translucent material to allow penetration of the Light Energy to the Light Energy Reaction Chamber [52]; wherein, at least a portion of the Infrared is absorbed by the Aqueous Solution; wherein, at least a portion of Visible passes through the Light Energy Reaction Chamber [52] and lands on PV [51] to create electrical current; wherein, the electrical current is sent to an electrolysis cell [49] such that at least a portion of the H₂O in Aqueous Solution is converted into H₂ and O₂ by the electrical current; wherein, Aqueous solution that is not converted into H₂ and O₂ in electrolysis cell [49] flows to gas/liquid separator [46]; wherein, the separated gas turns a steam turbine that drives a Generator that creates electrical current that is rectified and further supplied to electrolysis cell [49] for conversion of the Aqueous Solution into H₂ and O₂; wherein the temperature and pressure of separation [46] is measured by sensors [48] that send a temperature and a pressure signal to controller [47] that compares the temperature and pressure signal to that of a set-point; wherein, the difference between the temperature and pressures signals to that of the set-point creates a calculated difference in controller [47] that sends a signal proportional to the difference to control valve [44] to regulate gas flow from the separator and sends a signal proportional to the difference to control valve [45] to regulate liquid flow from separator [46]; wherein, liquid from separator [46] flows to a recycle point in the H₂O supply line; and wherein, temperature and pressure in line [53] after Light Energy Reaction Chamber [52] is measured by sensors [50] that send a temperature and pressure signal to controller [42] that compares the temperature and pressure signal to a set-point obtaining a difference; and, wherein, the controller [42] sends a signal that is proportional to the difference to flow control valve [41] to regulate H₂O flow.

FIG. 10 illustrates a graphical representation of the instant invention to produce at least one of H₂ and O₂ from H₂O and Light Energy comprising collection of Light Energy (Sunlight). FIG. 10 illustrates a graphical representation of a flow diagram to produce at least one of H₂ and O₂ from H₂O and Light Energy; wherein, electrolyte flow is controlled via control valve [56] which receives a flow control signal from controller [55] that creates the flow control signal from a calculated deviation from a desired set-point that is compared to conductivity of the water as measured by sensor [54]; wherein, Light Energy is collected by at least one collector [29] of dish type design sending Light Energy to the Light Energy reaction chamber [52]; wherein, the Aqueous Solution, comprising H₂O and electrolyte, flows via pipe [53] to Light Energy reaction chamber [52] that preferably comprises a translucent material to allow penetration of Light Energy to the Light Energy reaction chamber [52]; wherein, at least a portion of Infrared is absorbed by the Aqueous Solution; wherein, at least a portion of Visible passes through Light Energy Reaction Chamber [52] and lands on a PV [51] to create an electrical current; wherein, the electrical current is sent to an electrolysis cell [49] such that at least a portion of the H₂O in Aqueous Solution is converted into H₂ and O₂ by the electrical current; wherein, aqueous solution not converted into H₂ and O₂ in electrolysis cell [49] flows to gas/liquid separator [46]; wherein, the separated gas flows to and turns a steam turbine that drives a Generator that creates electrical current that is rectified and supplied to electrolysis cell [49] for conversation of the Aqueous Solution into H₂ and O₂; wherein the temperature and pressure of separation [46] is measured by sensors [48] that send a temperature and a pressure signal to controller [47] that compares the temperature and pressure signal to that of a set-point; wherein, the difference between the temperature and pressures signals to that of the set-point creates a calculated difference in controller [47] that sends a signal proportional to the difference to control valve [44] to regulate gas flow from the separator and sends a signal proportional to the difference to control valve [45] to regulate liquid flow from separator [46]; wherein, liquid from separator [46] flows to a system recycle point in the H₂O line; and wherein, temperature and pressure in line [53] after Light Energy reaction chamber [52] is measured by sensors [50] that send a temperature and pressure signal to a controller [42] that compares the temperature and pressure signal to a set-point obtaining a difference; and, wherein, controller [42] sends a signal that is proportional to the difference to control valve [41] to regulate H₂O flow.

FIG. 11 illustrates a graphical representation of FIGS. 9 and 10 to produce at least one of H₂ and O₂ from H₂O and Light Energy comprising a dish-type design [29] to collect Light Energy from Sunlight; wherein, a number of dishes are arranged in a line. Front and back depictions are shown of the in-line dish-type design comprising Infrared adsorption in the Light Energy reaction chamber [52] with flow of Aqueous Solution [53] and PV equipment [51] that creates an electrical current.

FIG. 12 illustrates a graphical representation of FIGS. 9 and 10 to produce at least one of H₂ and O₂ from H₂O and Light Energy comprising a trough-type design [57] to collect Light Energy from Sunlight; wherein, a mirrored trough collects Light Energy. Front and back depictions are shown of the in-line trough-type design comprising Infrared adsorption in the Light Energy reaction chamber [52] with flow of Aqueous Solution [53] and PV equipment [51] that creates an electrical current.

FIG. 13 illustrates a graphical representation of Light Energy Collection via a dish or trough type of design, dish [29] or trough [57]; wherein, a line of dish or the line of a trough is north-south so that Light Energy Collection can be rotated or moved from the East Horizon [58] to the West Horizon [59] to maximize Light Energy Collection, depending on the time of day, e.g. position of the Sun.

FIG. 14 illustrates a graphical representation of the instant invention to produce Visible Light Energy for a PBR comprising a dish-type design [29] to collect Light Energy from Sunlight; wherein, a number of dishes are arranged in a line. Front and back depictions are shown of the in-line dish-type design comprising Infrared adsorption in the Light Energy in reaction chamber [52] with flow of Aqueous Solution [53] and collection/transfer of Visible via transfer line [30] that transfers Visible to the PBR.

FIG. 15 illustrates a graphical representation of the instant invention to produce Visible Light Energy for a PBR comprising a trough-type design [57] to collect Light Energy from Sunlight. Front and back depictions are shown of the in-line trough-type design comprising Infrared adsorption in the Light Energy in reaction chamber [52] with flow of Aqueous Solution [53] and collection/transfer of Visible via transfer line [30] that transfers Visible to the PBR.

FIG. 16 illustrates in a block diagram the instant invention as it applies to ICE; wherein, H₂ and O₂, along with H₂O, are reacted in a combustion engine [60]; wherein, exhaust gas energy is converted into electrical current via a steam turbine/Generator/rectifier combination [18]; wherein, condensate from the steam turbine [18] is reacted with the electrical current from the Generator/rectifier [18] in an electrolysis cell [24]; wherein, the condensate is converted into H₂ and O₂; and wherein, the H₂ and O₂ are recycled to the Engine; wherein, the Engine [60] is insulated; wherein, H₂O is added to the Engine [60]; such that, available work is 40 to 80% of combustion energy.

FIG. 17 illustrates a graphical representation of the work, pressure-volume, diagram of the Haase Cycle.

FIG. 18 illustrates a graphical representation of a flow diagram of the most preferred embodiment of the instant invention. Light Energy is collected via a mirrored dish [29] or trough [57]; after which, Infrared is absorbed in Aqueous Solution [PH₂O] in Light Energy Reaction Chamber [52] that obtains flow of Aqueous Solution from pump [67]; wherein, steam [St] from Light Energy Reaction Chamber [52] is transferred via line 53 to compressor [76]; wherein, Visible [Li] from Light Energy reaction chamber [52] flows directly to a PBR [84] or to a Visible distribution chamber [28] and/or flows to PV [51] to create an electrical current; wherein, H₂O flows to heat exchanger [61] cooling a flow comprising H₂ and CO₂ [HCO₂] from Reformer [64], heat exchanger [68] and heat exchanger [66]; wherein, CH₄ combusts to heat the H₂O flow in heat exchanger [66] to create steam, as needed by Reformer [65]; wherein, Reformer [65] CH₄ and H₂O [StC] are converted into CO and H₂; wherein, the CO and H₂ product of Reformer [65], comprising H₂ and CO, flow to heat exchanger [63] and pre-heat the mixture comprising CH₄ and H₂O [StC] that flow to Reformer [65]; wherein, flow comprising H₂ and CO from heat exchanger [63] travels to heat exchanger [62]; wherein, the flow comprising H₂ and CO are preheated by a flow of H₂ and CO₂ from Reformer [64] that converts the CO and H₂O from Reformer [65] into CO₂ and H₂; wherein, hot water [HH₂O] from steam turbine [80] flows to heat exchanger [68] heating the H₂O which flows to CO₂ adsorption column [83]; wherein, the hot water [HH₂O] that entered heat exchanger [68] leaves as cold water [CH₂O] flowing to Combustion Chamber [79]; wherein, the steam from the Light Energy Reaction Chamber [St] combines with CH₄ and flows to compressor [76], leaving compressor [76] as a mixture comprising Steam and CH₄ [StC] that flows to heat exchanger [63] for pre-heating prior to entering Reformed [65]; wherein, air is compressed in compressor [77] flowing from compressor [77] as [A1] to heat exchanger [73]; wherein, [A1] is cooled by chilled N₂ flow in heat exchanger [72]; wherein, [A1] from heat exchanger [73] flows through a Joule Thompson expansion prior to entering separator [75]; wherein, air [A2] is separated from waste water [WH₂O]; wherein, [A2] flows to compressor [78] from which compressed air [A3] flows to heat exchanger [71]; wherein air flow [A3] is cooled by cryogenic N₂ from separation column [69]; wherein, after heat exchanger [71], the air [A3] from compressor [78] is expanded in a Joule-Thompson device prior to flowing to separation column [70]; wherein, reflux from separation column [70] is split to flow partially to the reflux and partially to the bottom of separation column [69]; wherein, the bottom of separation column [70] flows to the middle of separation column [69]; wherein, pure cryogenic N₂ leaves the reflux of separation column [69] and flows to heat exchanger [71]; wherein, pure cryogenic O₂ flows from the bottom of separation column [69] to Combustion Chamber [79]; wherein, the cryogenic N₂ from heat exchanger [71] flows to heat exchanger [72] to cool the flow of H₂ and CO₂[HCO₂] from heat exchanger [61]; wherein, the flow of cooled H₂ and CO₂[HCO₂] from heat exchanger [72] flows to separator [74]; wherein, H₂[H₂] is separated and flows to Combustion Chamber [79]; wherein, the CO₂[CO₂] from separator [72] flows to absorption column [82]; wherein, the chilled N₂ from heat exchanger [72] flows to heat exchanger [73] cooling the flow of air [A1] from compressor [76]; wherein, a portion of the chilled N₂ from heat exchanger [72] flows to available refrigeration needs [WN₂1]; wherein the cooled N₂ from heat exchanger [73] flows to available refrigeration needs [WN₂2]; wherein, a mixture comprising CO₂ and H₂O flows from absorption column [82] to PBR [27]; wherein, Visible [Li] from the Light Energy Reaction Chamber [52] enters a mirrored distribution chamber [28]; wherein, Visible is distributed into the PBR via photon tubes; wherein, O₂ from the PBR [O₂B] flows to and mixes with the air flow to separation column [70]; wherein, aqueous flow from PBR [27] flows to centrifuge [33] that separates aqueous into two streams, one that has a greater percentage of water than that of the PBR [27] and one that has a greater percentage of bio-solids than that of the PBR [27]; wherein, the stream that has a greater percentage of water than that of the PBR [27] is recycled to absorption column [82]; wherein, the stream that has a greater percentage of bio-mass than the PBR [27] enters a second centrifuge [83]; wherein, a stream of further bio-solids concentration is created and is used as algae product [Algae]; wherein, the O₂ and H₂ are combusted in Combustion Chamber [79] to create steam flow to steam turbine(s) [80]; wherein, the steam turbine(s) creates electricity by turning Generator [81]; and wherein, the steam turbine(s) powers the entire system, driving compressors [76], [77] and [78], as well as Generator [81]. As depicted, it is preferred that compressors [76], [77] and [78], along with Generator [81], share a common drive shaft with steam turbine [80]. It is an embodiment that electrical current created by PV [51] or Generator [81] be used in electrolysis of Aqueous Solution to create H₂ and O₂; wherein, at least a portion of the H₂ and O₂ flow to the Combustion Chamber [79].

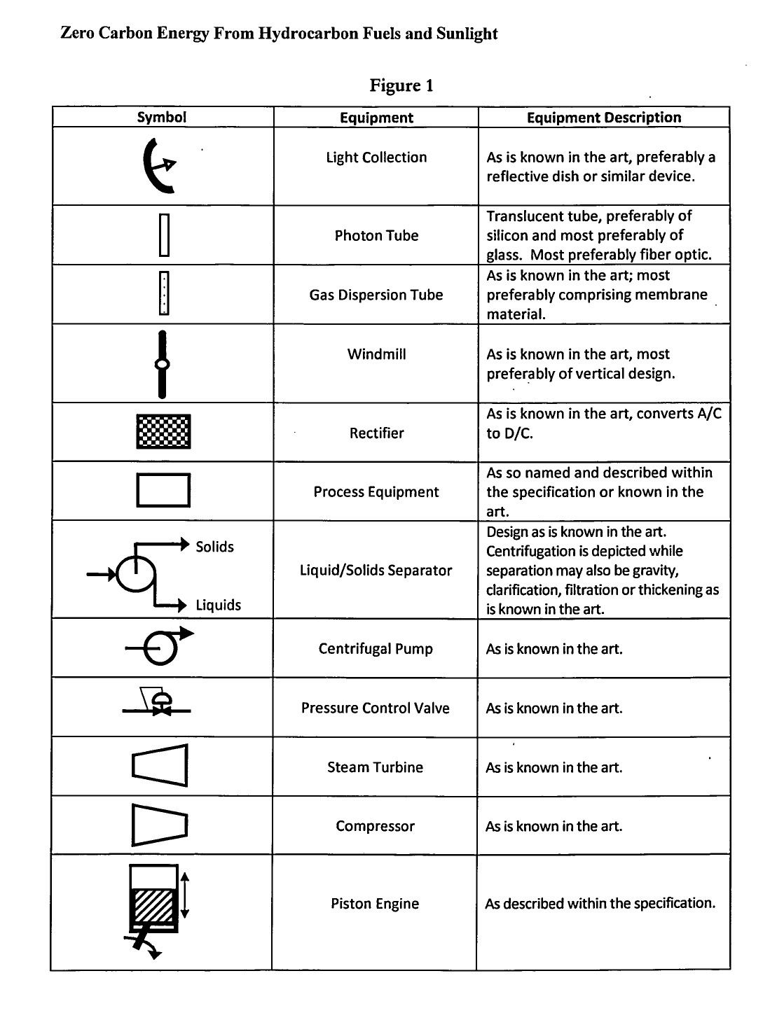

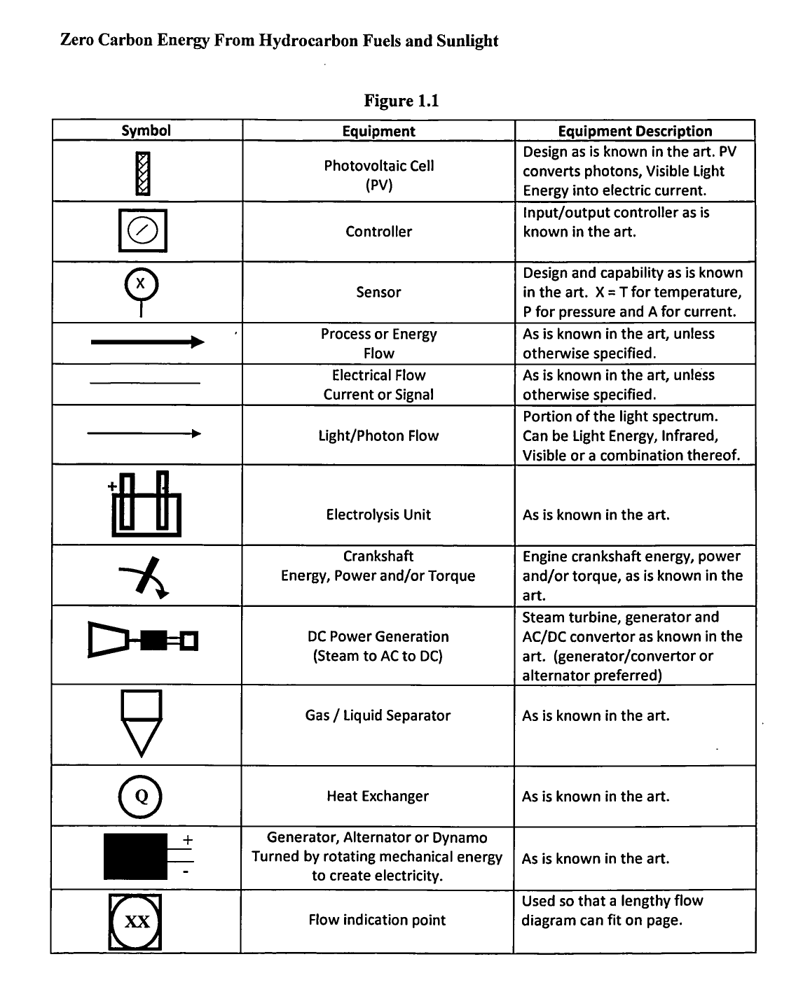

### DETAILED DESCRIPTION OF THE PREFERRED EMBODIMENTS

Timing of the instant invention is significant and meets a long felt need of humanity; as, global climate change is changing weather patterns of Earth. Timing of the instant invention is significant and meets a long felt need; as, global climate change is becoming a global political issue. Timing of the instant invention is significant and meets a long felt need of humanity; since, the products of hydrocarbon combustion are now affecting the health of humanity, as well as that of animals, plant and sea life on Earth. Timing of the instant invention is significant and meets a long felt need of humanity; as, the instant invention significantly improves efficiency of Hydrocarbons in power (electricity) generation and in Transportation.

The instant invention presents environmentally friendly Application Means, which are powerful and efficient, thereby efficacious, and which require a reasonable amount of tooling to implement. And, in the case of transportation, Application Means presents a combustion process, which will have a “feel” to the driver similar to that of hydrocarbon combustion engines; this “feel” will further acceptance of the instant invention.

The instant invention is described in connection with one or more preferred embodiments. However, it should be understood that the invention is not limited to those embodiments. In contrast, the invention includes all alternatives, modifications and equivalents as may be included within the spirit and scope of the specification and of the instant claims as readily determined from the specification by one of ordinary skill in the art.

### Light Energy

Light Energy comprises many wavelengths of the light spectrum. The instant invention embodies wavelengths of the light spectrum from about 1×10⁻⁸ meter to about 4×10⁻⁶ meter. The instant invention embodies two portions of Energy, Infrared and Visible. The instant invention embodies that Infrared portion of Light Energy comprising wavelengths of greater than about 1×10⁻⁶ meter. The instant invention embodies the Visible portion of Light Energy comprising wavelengths from about 1×10⁻⁸ meter to about 1×10⁻⁶ meter. The instant invention embodies adding heat to an Aqueous Solution; wherein, at least a portion of the heat comprises Infrared. The instant invention embodies electrolysis of at least a portion of an Aqueous Solution to produce H₂ and O₂ from H₂O; wherein, at least a portion of electricity of electrolysis is from PV. The instant invention embodies electrolysis of at least a portion of an Aqueous Solution to produce H₂ and O₂ from H₂O; wherein, at least a portion of the electricity of electrolysis is from PV; wherein, electricity from PV is at least partially obtained from Visible. The instant invention embodies electrolysis of at least a portion of an Aqueous Solution to produce H₂ and O₂ from H₂O; wherein, at least a portion of the electricity of electrolysis is from PV; wherein, the electricity from PV is at least partially obtained from Visible; and wherein, at least a portion of the Visible is separated from Infrared in Light Energy. The instant invention embodies electrolysis of at least a portion of an Aqueous Solution to produce H₂ and O₂ from H₂O; wherein, at least a portion of the electricity of electrolysis is from PV; wherein, the electricity from PV is at least partially obtained from Visible; wherein, the Visible is separated from Infrared in Light Energy; and wherein, heat is added to the Aqueous Solution. The instant invention embodies electrolysis of at least a portion of an Aqueous Solution to produce H₂ and O₂ from H₂O; wherein, at least a portion of the electricity of electrolysis is from PV; wherein, the electricity from PV is at least partially obtained from Visible; wherein, the Visible is separated from Infrared in Light Energy; wherein, heat is added to the Aqueous Solution; and wherein at least a portion of the heat comprises Infrared. The instant invention embodies electrolysis of at least a portion of an Aqueous Solution to produce H₂ and O₂ from H₂O; wherein, at least a portion of the electricity of electrolysis is from PV; wherein, at least a portion of the electricity from PV is obtained from Visible; wherein, the Visible is separated from Infrared in Light Energy; wherein, heat is added to the Aqueous Solution; wherein at least a portion of the heat comprises Infrared; and wherein, the heat added to the Aqueous Solution is at least one of at least partially prior to and at least partially in combination with electrolysis.

It is an embodiment that at least one of an Aqueous Solution and H₂O portion of the Aqueous Solution separate Infrared from Light Energy. It is most preferred that at least one of Aqueous Solution and H₂O portion of the Aqueous Solution absorb Infrared from Light Energy. It is most preferred that Light Energy be applied to Aqueous Solution and that the Aqueous Solution absorb Infrared from Light Energy. It is most preferred that Light Energy be applied to H₂O and that H₂O absorb Infrared from Light Energy. It is preferred that Aqueous Solution comprises a metal cation. It is most preferred that the metal cation comprise copper (Cu).

It is a preferred embodiment that at least a portion of the Visible portion of Light Energy pass through at least one of Aqueous Solution and H₂O. It is preferred that an electrical current is produced by PV; wherein, at least a portion of the electrical current is produced by at least a portion of Visible; and wherein, at least a portion of Visible pass through at least one of Aqueous Solution and H₂O. It is a preferred embodiment to perform electrolysis on at least one of Aqueous Solution and H₂O; wherein, the electrolysis comprise an electrical current; wherein, at least a portion of the electrical current is produced by PV; wherein, the electrical current produced by PV is produced by at least a portion of Visible; and wherein, at least a portion of the Visible pass through the at least one of Aqueous Solution and H₂O. It is a preferred embodiment to produce at least one of H₂ and O₂ from at least one of Aqueous Solution and H₂O; wherein, electrolysis is performed on the at least one of Aqueous Solution and H₂O; wherein, the electrolysis comprise an electrical current; wherein, at least a portion of the electrical current is from PV; wherein, at least a portion of the electrical current from PV is produced by at least a portion of Visible; and wherein, at least a portion of the Visible pass through at the least one of the Aqueous Solution and H₂O. It is a preferred embodiment to produce at least one of H₂ and O₂ from at least one of Aqueous Solution and H₂O; wherein, electrolysis is performed on the at least one of Aqueous Solution and H₂O; wherein, the electrolysis comprise an electrical current; wherein, PV produce at least a portion of the electrical current; wherein, at least a portion of the electrical current is from PV; wherein, at least a portion of the electrical current from PV is produced by at least a portion of Visible; wherein, at least a portion of the Visible pass through at the least one of Aqueous Solution and H₂O; and wherein, heat is added to the at least one of Aqueous Solution and H₂O. It is a preferred embodiment to produce at least one of H₂ and O₂ from at least one of Aqueous Solution and H₂O; wherein, electrolysis is performed on the at least one of Aqueous Solution and H₂O; wherein, the electrolysis comprise an electrical current; wherein, at least a portion of the electrical current is from PV; wherein, at least a portion of the electrical current from PV is produced by at least a portion of Visible; wherein, at least a portion of the Visible pass through at the least one of Aqueous Solution and H₂O; wherein, heat is added to the at least one of Aqueous Solution and H₂O; and wherein, the heat comprise Infrared from Light Energy. It is a preferred embodiment to produce at least one of H₂ and O₂ from at least one of Aqueous Solution and H₂O; wherein, electrolysis is performed on the at least one of Aqueous Solution and H₂O; wherein, the electrolysis comprise an electrical current; wherein, at least a portion of the electrical current is from PV; wherein, at least a portion of the electrical current from PV is produced by at least a portion of Visible; wherein, at least a portion of the Visible pass through at the least one of Aqueous Solution and H₂O; wherein, heat is added to the at least one of Aqueous Solution and H₂O; wherein, the heat comprise Infrared from Light Energy; and wherein, the heat added is at least one of partially prior to and in combination with the electrolysis.

### Light Energy Collection

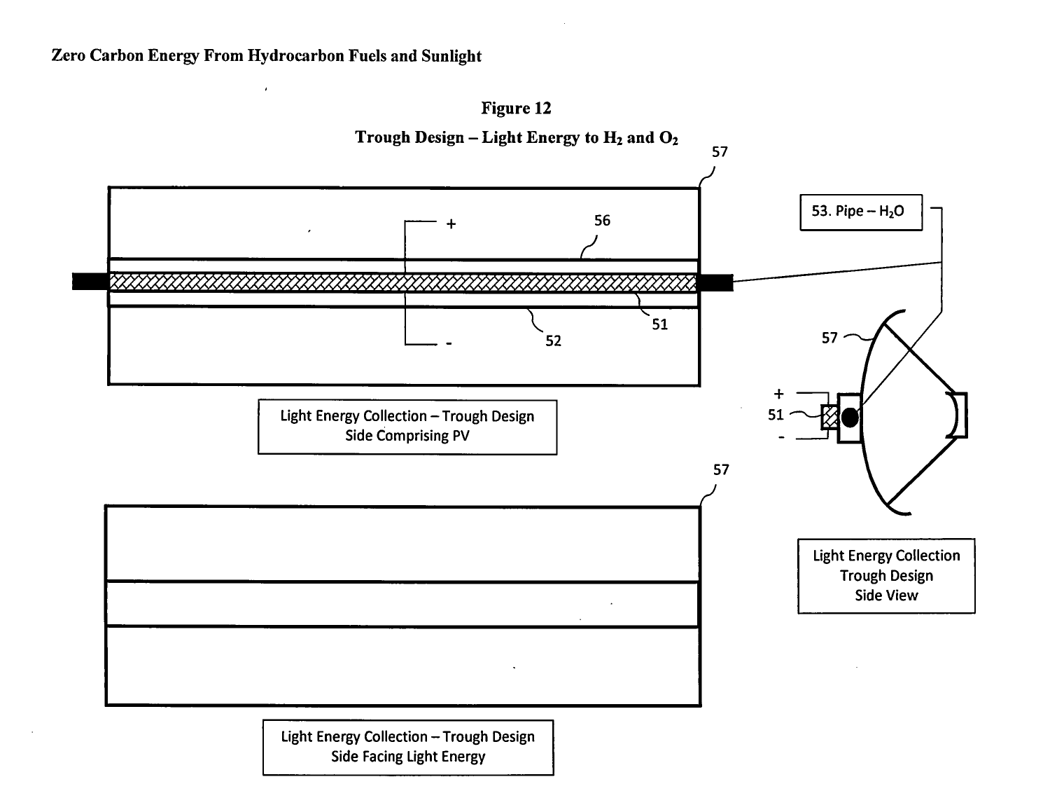

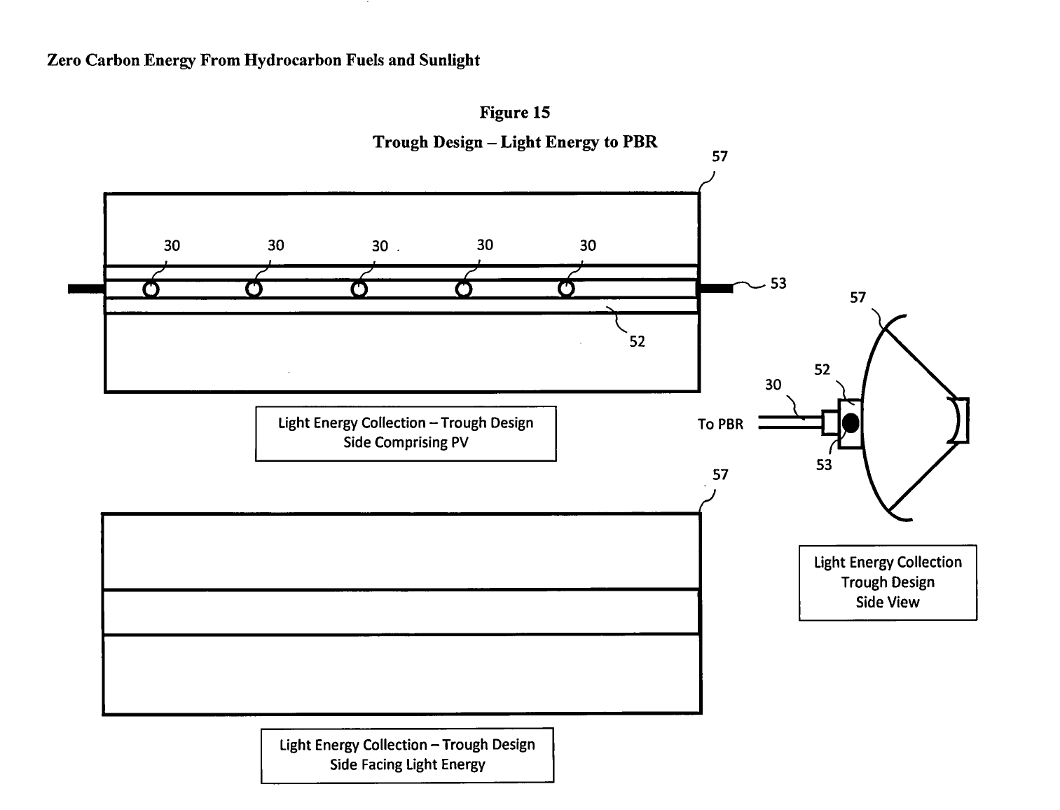

It is an embodiment that Light Energy collection comprise a Dish (within the instant invention, Dish is defined as any reflective Means to gather Light Energy to a focal point). Therefore, Light Energy collection may be performed in a reflective trough, as depicted in FIGS. 12 and 15.

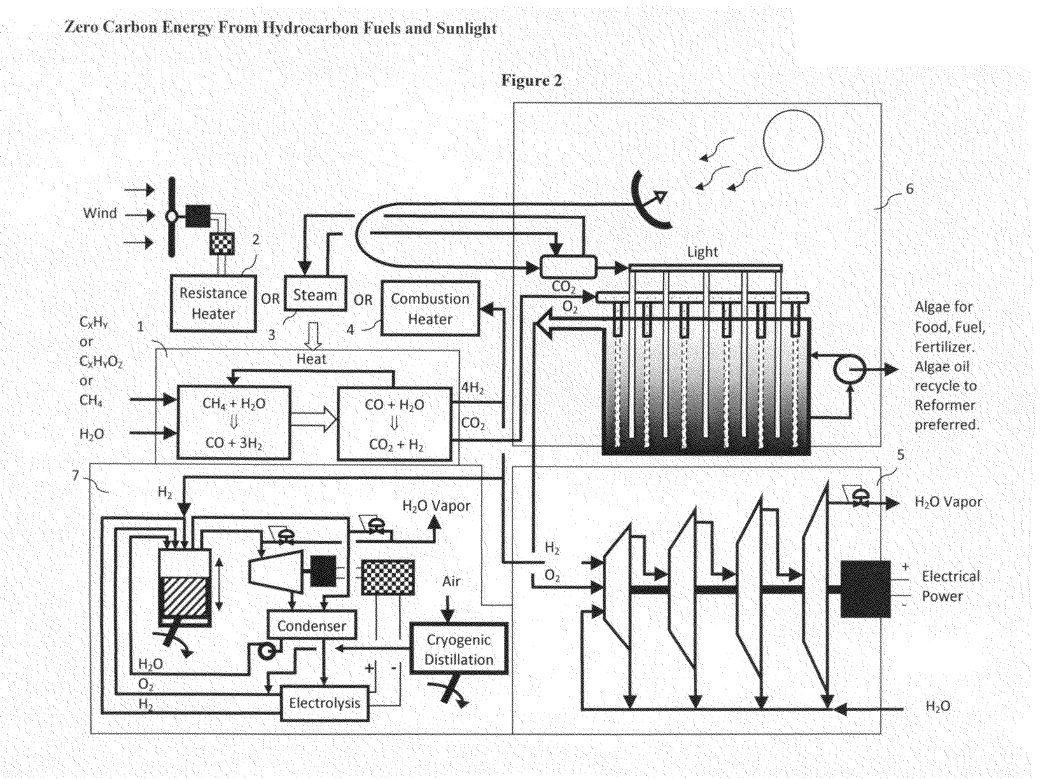

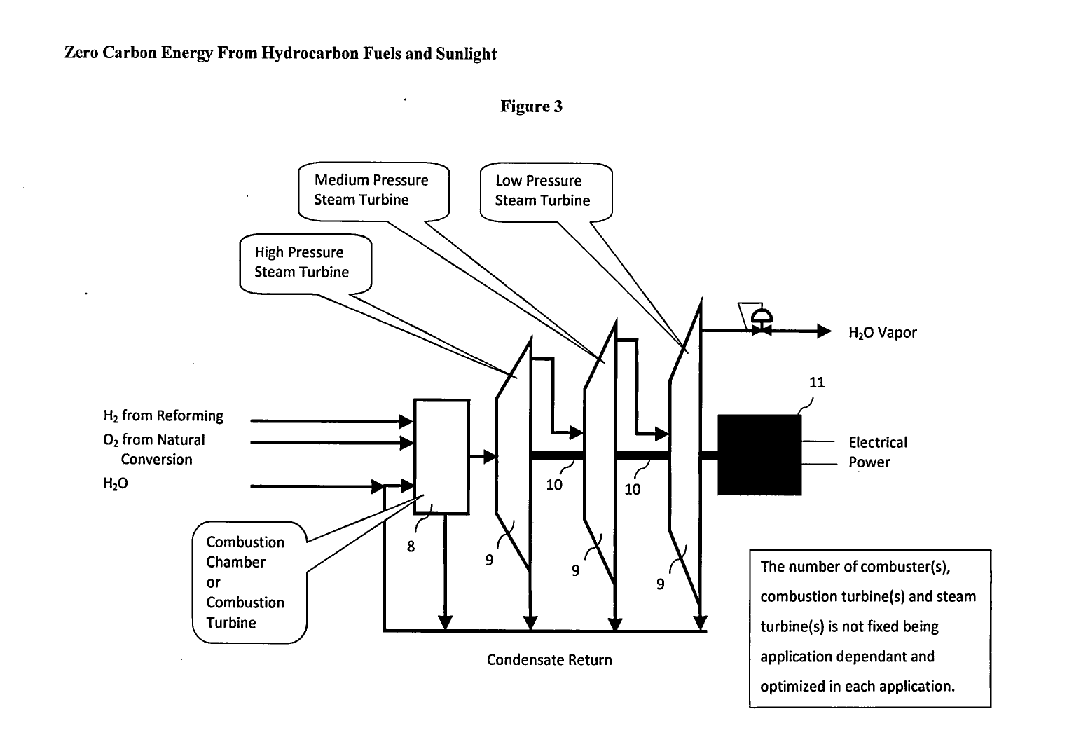

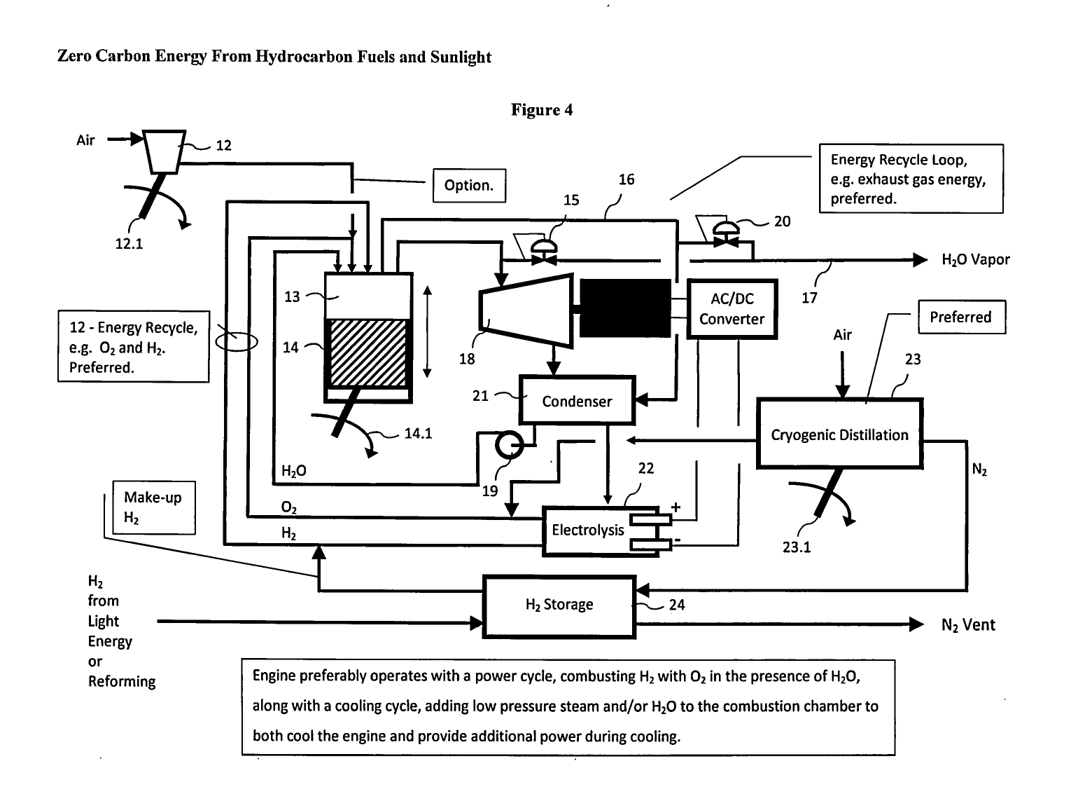

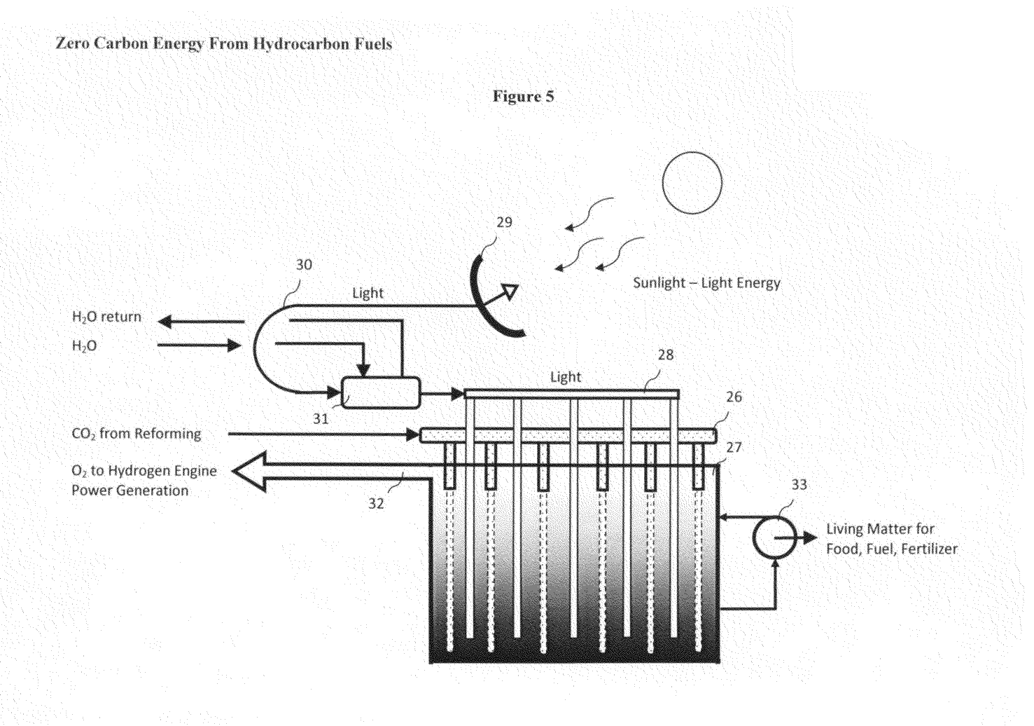

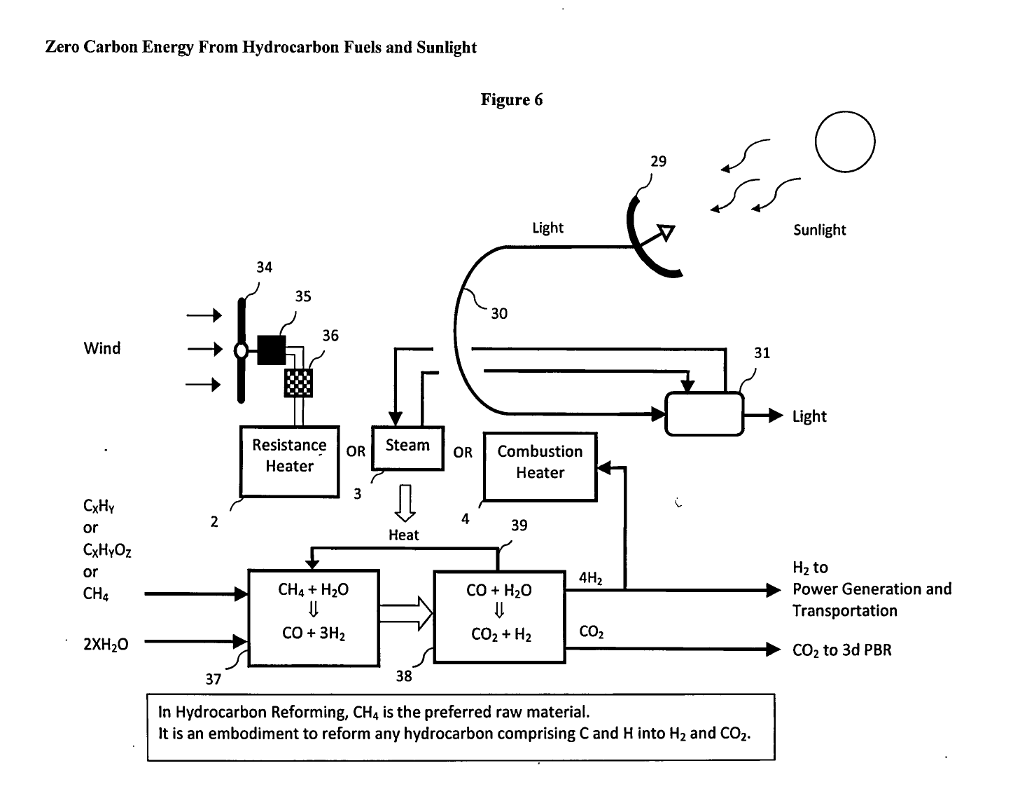

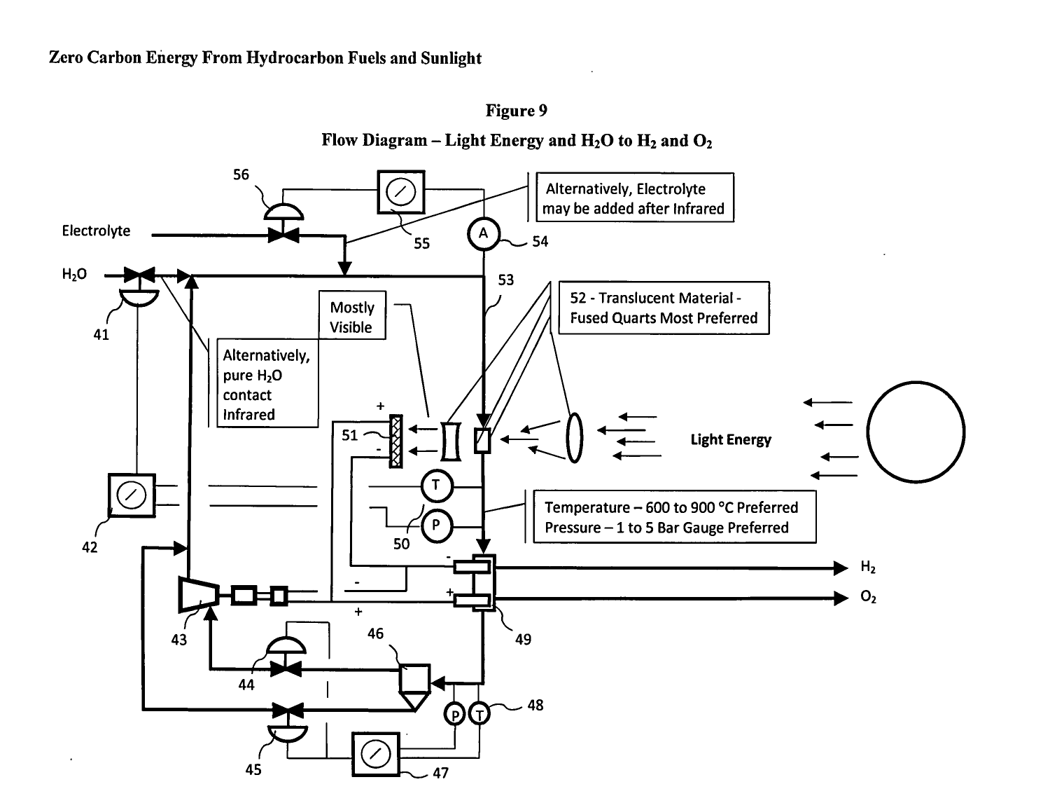

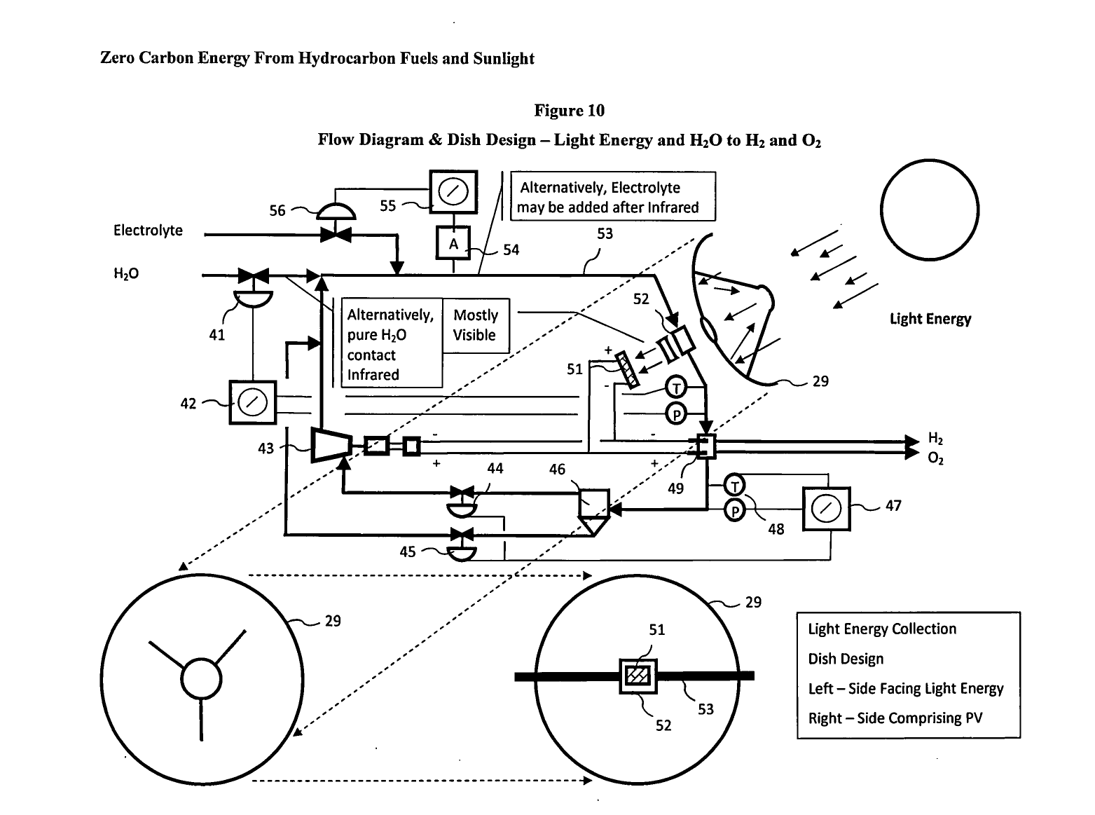

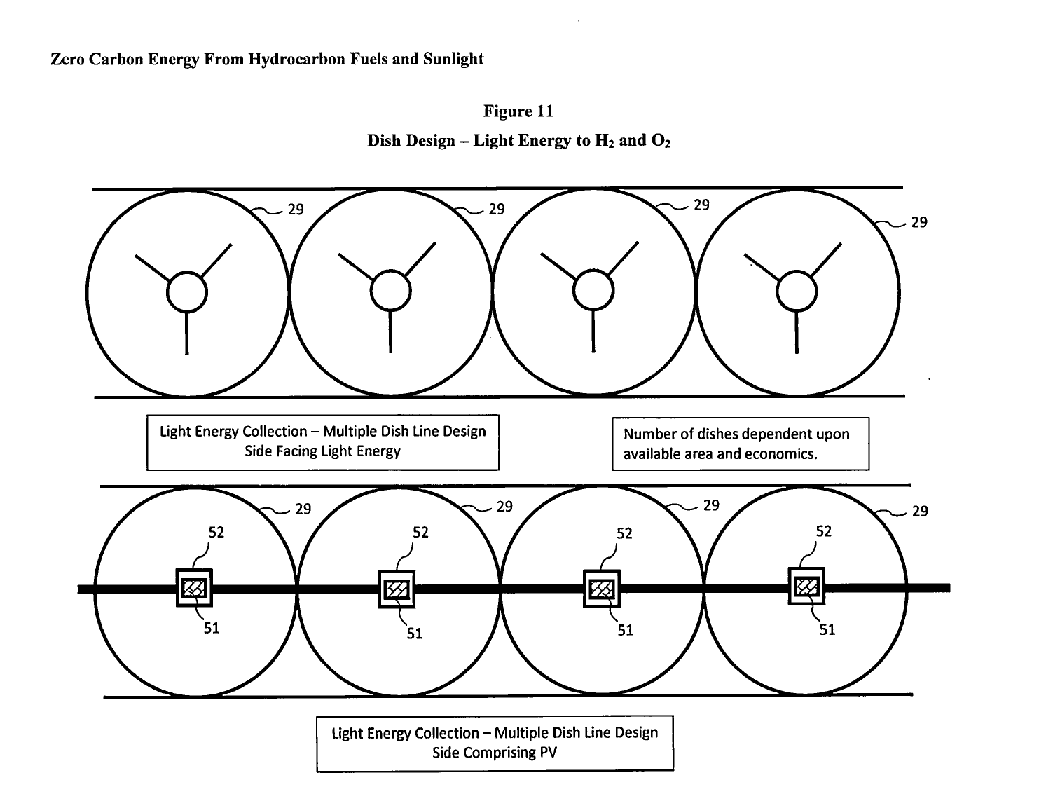

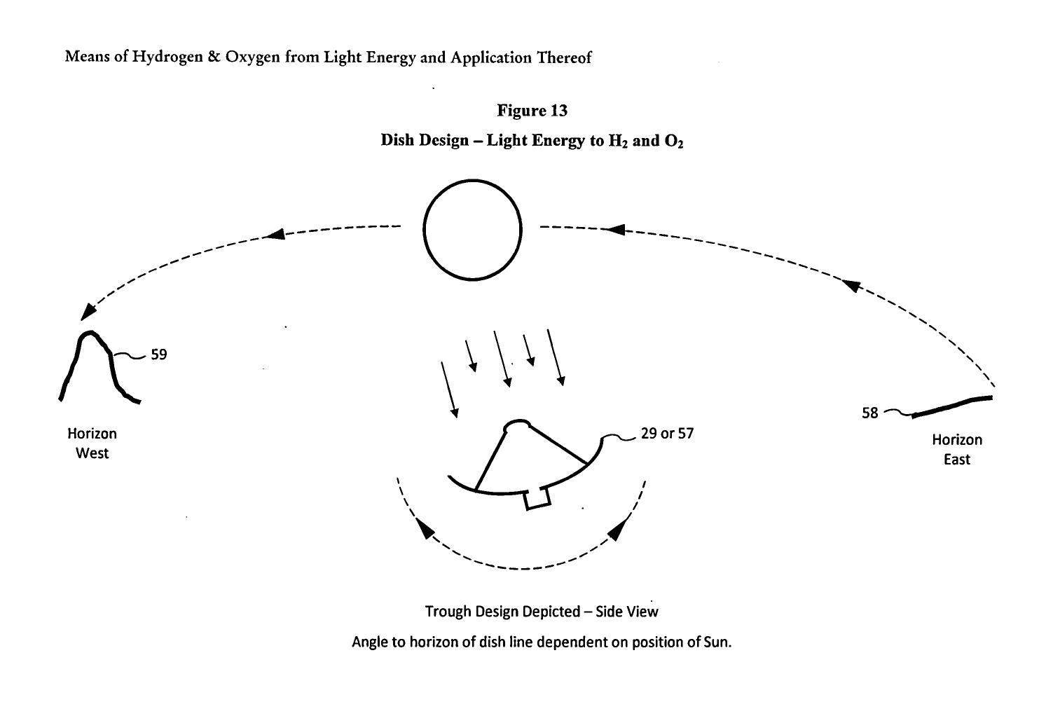

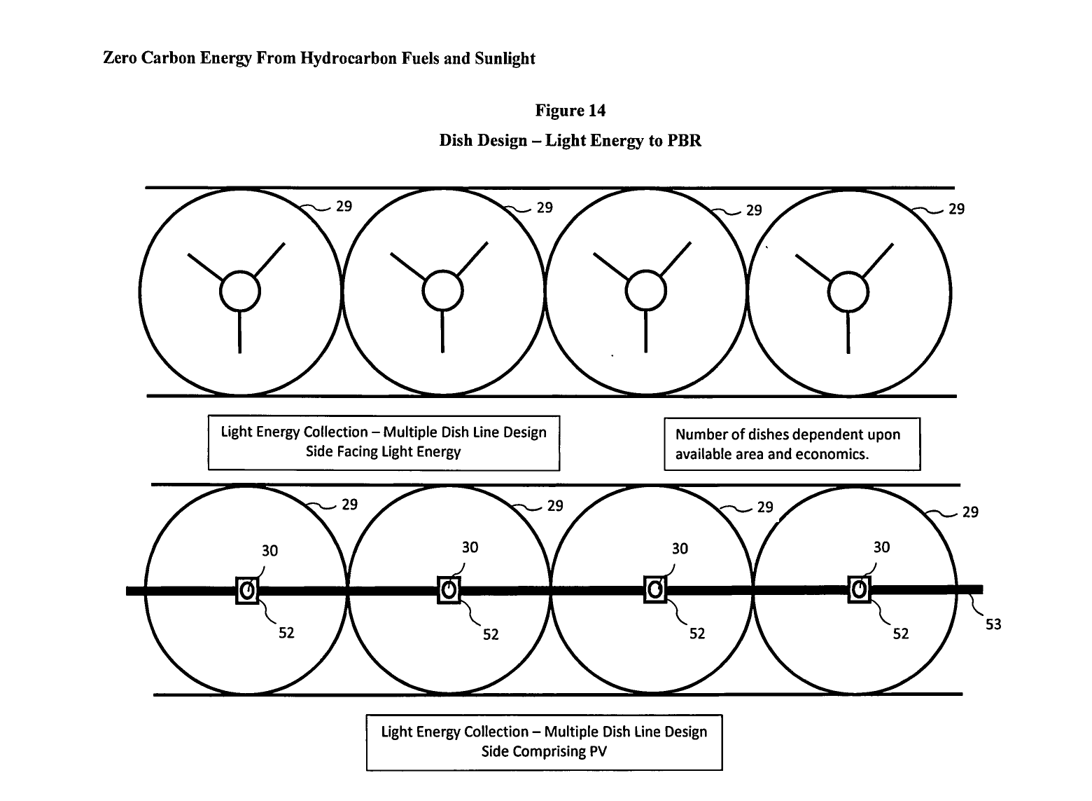

It is an embodiment to collect Sunlight for Light Energy, as depicted in FIGS. 2, 5, 6 and 9-15. It is a preferred embodiment to collect Light Energy via the traditional dish-type design (Dish), as depicted in FIGS. 2, 5, 6, 10, 11 and 14. It is a preferred embodiment to collect Light Energy with a number of Dish, as depicted in FIGS. 11 and 14; wherein, the number of Dish is defined by space and economics. It is most preferred to arrange a number of Dish in a line, as depicted in FIGS. 11 and 14; wherein, the line is arranged about north-south; such that all Dish in the line may collect Light Energy from Sunlight and from horizon to horizon, as depicted in FIG. 13; as, the Sun moves across the sky from East to West. It is most preferred that each Dish rotate with and be toward the Sun as the Sun moves in relation to rotation of the Earth from horizon to horizon. It is preferred to have a number of line of Dish.

It is an embodiment that at least one Dish comprise a focal point to collect Light Energy, as depicted in FIGS. 2, 5, 6, 10, 11 and 14. It is preferred that at least one Dish comprise a focal point to collect Light Energy, as depicted in FIGS. 2, 5, 6, 10, 11 and 14; wherein, the focal point is a mirrored surface providing a concentration of the collected Light Energy. It is preferred that at least one Dish comprise a mirrored surface and a focal point to collect Light Energy, as depicted in FIGS. 2, 5, 6, 10, 11 and 14. It is preferred that at least one Dish comprise a focal point to collect Light Energy, as depicted in FIGS. 2, 5, 6, 10, 11 and 14; and wherein, at least a portion of the concentrated Light Energy contact at least one of an Aqueous Solution and H₂O. It is preferred that at least one Dish comprise a focal point to collect Light Energy, as depicted in FIGS. 2, 5, 6, 10, 11 and 14; and wherein, at least a portion of the concentrated Light Energy contact at least one of an Aqueous Solution and H₂O; such that, heat energy is added to the at least one of an Aqueous Solution and H₂O. It is preferred that at least one Dish comprise a focal point to collect Light Energy, as depicted in FIGS. 2, 5, 6, 10, 11 and 14; and wherein, at least a portion of the concentrated Light Energy contact at least one of an Aqueous Solution and H₂O; such that, heat energy is added to the at least one of an Aqueous Solution and H₂O; and such that, at least a portion of Visible pass through at least one of an Aqueous Solution and H₂O. It is preferred that at least one Dish comprise a focal point to collect Light Energy, as depicted in FIGS. 2, 5, 6, 10, 11 and 14; and wherein, at least a portion of the concentrated Light Energy contact at least one of an Aqueous Solution and H₂O; such that, heat energy is added to the at least one of an Aqueous Solution and H₂O; and such that, at least a portion of Visible pass through at least one of an Aqueous Solution and H₂O; wherein, at least a portion of the Visible contact a PV or 3d PBR. It is preferred that at least one Dish comprise a focal point to collect Light Energy, as depicted in FIGS. 2, 5, 6, 10, 11 and 14; and wherein, at least a portion of the concentrated Light Energy contact at least one of an Aqueous Solution and H₂O; such that, heat energy is added to the at least one of an Aqueous Solution and H₂O; and such that, at least a portion of Visible pass through at least one of an Aqueous Solution and H₂O; wherein, at least a portion of the Visible contact a PV or 3d PBR; such that the PV create an electrical current and/or the 3dPBR convert CO₂ into O₂ and bio-mass. It is preferred that at least one Dish comprise a focal point to collect Light Energy, as depicted in FIGS. 2, 5, 6, 10, 11 and 14; and wherein, at least a portion of the concentrated Light Energy contact at least one of an Aqueous Solution and H₂O; such that, heat energy is added to the at least one of an Aqueous Solution and H₂O; and such that, at least a portion of Visible pass through at least one of an Aqueous Solution and H₂O; wherein, at least a portion of the Visible contact a PV or 3d PBR; such that the PV create an electrical current and/or the 3d PBR convert CO₂ into O₂ and bio-mass; wherein, at least a portion of the electrical current perform electrolysis on the at least one of an Aqueous Solution and H₂O; such that, H₂ and O₂ are created from H₂O. It is most preferred that said Dish comprise a mirrored trough, as depicted in FIGS. 12 and 15.

### Aqueous Solution

It is an embodiment to create an Aqueous Solution. It is an embodiment that the Aqueous Solution comprises H₂O. It is an embodiment to create an Aqueous Solution comprising H₂O and at least one Electrolyte. It is an embodiment to create an Aqueous Solution comprising H₂O and at least one Electrolyte; wherein, the Electrolyte is a cation and anion pair. It is an embodiment to create an Aqueous Solution comprising H₂O and at least one Electrolyte; wherein, the Electrolyte is a cation and anion pair; wherein, the cation comprises an atom or compound; and wherein, the anion comprises an atom or compound. It is an embodiment to create an Aqueous Solution comprising H₂O and at least one Electrolyte; wherein, the Electrolyte is a cation and anion pair; wherein, the cation comprises an atom or compound; wherein, the anion comprises an atom or compound; and wherein, a compound may or may not comprise carbon (“C”). It is preferred that the cation comprise a metal. It is preferred that the cation comprise at least one selected from a list consisting of a: group I metal, group II metal, group IVB metal, group VIIB metal, group VIII metal, group IB metal, group JIB metal, and any combination therein. It is preferred that the cation comprise at least one selected from a list consisting of: Cu, nickel (“Ni”), iron (“Fe”), magnesium (“Mg”), platinum (“Pt”), titanium (“Ti”), silver (“Ag”), gold (“Au”), zinc (“Zn”), and any combination therein. It is preferred that the anion comprise a group VIIB nonmetal. It is preferred that the anion comprise phosphate (“PO₄”). It is preferred that the anion comprises at least one element selected from a: group IVA nonmetal, group VA nonmetal, group VIA nonmetal, and any combination therein. It is preferred that the anion comprise at least on element selected from a list consisting of: C, phosphorous (“P”), nitrogen (“N”), silicon (“Si”), oxygen (“O”), sulfur (“S”), and any combination therein.

It is an embodiment that the Aqueous Solution comprises any temperature above O° C. It is a preferred embodiment that the Aqueous Solution comprise a temperature of greater than about 100° C. and less than about 1200° C. It is a mostly preferred embodiment that the Aqueous Solution comprise a temperature of greater than about 300° C. and less than about 600° C. It is most preferred that the Aqueous Solution comprise a temperature of greater than about 600° C. and less than about 900° C. It is an embodiment that the Aqueous Solution comprises a liquid or gas.

It is an embodiment that the Aqueous Solution comprises any pressure absolute. It is preferred that the Aqueous Solution comprise a pressure of greater than about 1 bar to less than about 100 bar gauge. It is mostly preferred that the Aqueous Solution comprise a pressure of greater than about 1 bar and less than about 10 bar gauge. It is most preferred that the Aqueous Solution comprise a pressure of greater than about 1 bar and less than about 5 bar gauge.

Heating of Aqueous Solution and/or H₂O

It is embodied to heat at least one of an Aqueous Solution and H₂O. It is embodied to heat at least one of an Aqueous Solution and H₂O; wherein H₂O comprises a gas (steam). It is preferred to heat at least one of an Aqueous Solution and H₂O; wherein, at least a portion of the energy of heat comprises Light Energy. It is preferred to heat at least one of an Aqueous Solution and H₂O; wherein, at least a portion of the energy of heat comprises the Infrared portion of Light Energy. It is preferred to heat at least one of an Aqueous Solution and H₂O; wherein, at least a portion of the energy of heat comprises the Infrared portion of Light Energy; and wherein, the at least one of an Aqueous Solution and H₂O absorb at least a portion of Infrared. It is preferred to heat at least one of an Aqueous Solution and H₂O; wherein, at least a portion of the energy of heat comprises the Infrared portion of Light Energy; wherein, the at least one of an Aqueous Solution and H₂O absorb at least a portion of Infrared; and wherein, at least a portion of Visible passes through the at least one of an Aqueous Solution and H₂O.

It is an embodiment that Light Energy travel through at least one translucent material to contact the at least one of an Aqueous Solution and H₂O. It is a preferred embodiment that the Light Energy travel through at least one material comprising Si to contact the at least one of an Aqueous Solution and H₂O. It is a preferred embodiment that the Light Energy travel through at least one material comprising quartz to contact the at least one of an Aqueous Solution and H₂O. It is a most preferred embodiment that the Light Energy travel through at least one material comprising fused quartz to contact the at least one of an Aqueous Solution and H₂O.

After at least a portion of the Light Energy contacts at least a portion of the at least one of an Aqueous Solution and H₂O, it is an embodiment that at least a portion of the remaining wavelength portions of the Light Energy travel through a translucent material to contact PV and/or a 3d PBR. After at least a portion of the Light Energy contacts at least a portion of the at least one of an Aqueous Solution and H₂O, it is a preferred embodiment that at least a portion of the remaining wavelength portions of the Light Energy travel through a material comprising Si to contact PV and/or a 3d PBR. After at least a portion of the Light Energy contacts at least a portion of the at least one of an Aqueous Solution and H₂O, it is a preferred embodiment that at least a portion of the remaining wavelength portions of the Light Energy travel through a material comprising quartz to contact PV and/or a 3d PBR. After at least a portion of the Light Energy contacts at least a portion of the at least one of an Aqueous Solution and H₂O, it is a preferred embodiment that at least a portion of the remaining wavelength portions of the Light Energy travel through a material comprising fused quartz to contact PV and/or a 3d PBR. It is most preferred that the remaining wavelength portions of Light Energy comprise Visible.

### PV

It is preferred to heat at least one of an Aqueous Solution and H₂O; wherein, at least a portion of the energy of heat comprises the Infrared portion of Light Energy; wherein, the at least one of an Aqueous Solution and H₂O absorb at least a portion of Infrared; wherein, at least a portion of Visible passes through the at least one of an Aqueous Solution and H₂O; and wherein, the at least a portion of Visible passing through the at least one of an Aqueous Solution and H₂O contacts at least one PV and/or 3d PBR. It is preferred to heat at least one of an Aqueous Solution and H₂O; wherein, at least a portion of the energy of heat comprises the Infrared portion of Light Energy; wherein, the at least one of an Aqueous Solution and H₂O absorb at least a portion of Infrared; wherein, at least a portion of Visible passes through the at least one of an Aqueous Solution and H₂O; wherein, the at least a portion of Visible passing through the at least one of an Aqueous Solution and H₂O contacts at least one PV and/or 3d PBR; and wherein at least a portion of Visible is converted into electricity by the PV. It is preferred to heat at least one of an Aqueous Solution and H₂O; wherein, at least a portion of the energy of heat comprises the Infrared portion of Light Energy; wherein, the at least one of an Aqueous Solution and H₂O absorb at least a portion of Infrared; wherein, at least a portion of Visible passes through the at least one of an Aqueous Solution and H₂O; wherein, the at least a portion of Visible passing through the at least one of an Aqueous Solution and H₂O contacts at least one PV and/or 3d PBR; wherein at least a portion of Visible is converted into electricity by the PV; and wherein, at least a portion of the electricity performs electrolysis on the at least one of an Aqueous Solution and H₂O producing at least one of H₂ and O₂.

### Optics

It is an embodiment that at least a portion of the Light Energy travels through at least one lens. It is preferred that at least a portion of the Light Energy travel though at least one lens; such that, the lens concentrate the at least a portion of the Light Energy. It is preferred that at least a portion of the Light Energy travel though at least one lens; such that, the lens concentrate the at least a portion of the Light Energy prior to the at least a portion of the Light Energy contacting at least one of an Aqueous Solution and H₂O.

It is an embodiment that at least a portion of the Infrared travel through at least one lens. It is preferred that at least a portion of the Infrared travel though at least one lens; such that, the lens concentrate the at least a portion of the Infrared. It is preferred that at least a portion of the Infrared travel though at least one lens; such that, the lens concentrate the at least a portion of the Infrared prior to the at least a portion of the Infrared contacting at least one of an Aqueous Solution and H₂O.

It is an embodiment that at least a portion of the Visible travels through at least one lens. It is preferred that at least a portion of the Visible travel though at least one lens; such that, the lens at least partially evens distribution of the at least a portion of the Visible to contact PV.

### Electrolysis

It is an embodiment to perform electrolysis on at least one of an Aqueous Solution and H₂O (“Electrolysis”). It is a preferred embodiment to perform electrolysis on at least one of an Aqueous Solution and H₂O; wherein, the electricity of electrolysis is at least partially from PV, a

Generator driven by a Hydrogen Engine of the instant invention, stem produced by a Hydrogen Engine of the instant invention that drives a Generator and steam produced by Infrared that drives a Generator. It is a preferred embodiment to perform electrolysis on at least one of an Aqueous Solution and H₂O; wherein, the electricity of electrolysis is at least partially from PV; and wherein, the electricity from PV is at least partially obtained from Visible.

It is an embodiment that at least one of the electrodes for electrolysis comprises a metal. It is preferred that the at least one electrode comprise at least one selected from a list consisting of a: group I metal, group II metal, group IVB metal, group VIIB metal, group VIII metal, group IB metal, group IIB metal, and any combination therein. It is preferred that the at least one electrode comprise at least one selected from a list consisting of: Cu, Ni, Fe, Mg, Pt, Ti, Ag, Au, Zn, and any combination therein.

It is an embodiment that at least a portion of the electricity of electrolysis be generated from gas energy. It is preferred that at least a portion of the electricity of electrolysis be generated from gas energy; wherein the gas is at least partially created by Infrared. It is preferred that at least a portion of the electricity of electrolysis be generated from gas energy; wherein at least a portion of the gas is at least partially created by Infrared; wherein the Infrared is absorbed by at least a portion of an Aqueous Solution and H₂O. It is preferred that at least a portion of the electricity of electrolysis be generated from gas energy; wherein at least a portion of the gas is at least partially created by Infrared; wherein the Infrared is absorbed by at least a portion of an Aqueous Solution and H₂O; wherein, the at least a portion of the gas turns a turbine. It is preferred that at least a portion of the electricity of electrolysis be generated from gas energy; wherein at least a portion of the gas is at least partially created by Infrared; wherein the Infrared is absorbed by at least a portion of an Aqueous Solution and H₂O; wherein, the at least a portion of the gas turns a turbine; wherein, the turbine turns at least one of a generator and an alternator. It is preferred that at least a portion of the electricity of electrolysis be generated from gas energy; wherein at least a portion of the gas is at least partially created by Infrared; wherein the Infrared is absorbed by at least a portion of an Aqueous Solution and H₂O; wherein, the at least a portion of the gas turns a turbine; wherein, the turbine turns at least one of a generator and an alternator; wherein the at least one of a generator and an alternator create an electrical current. It is preferred that at least a portion of the electricity of electrolysis be generated from gas energy; wherein at least a portion of the gas is at least partially created by Infrared; wherein the Infrared is absorbed by at least a portion of an Aqueous Solution and H₂O; wherein, the at least a portion of the gas turns a turbine; wherein, the turbine turns at least one of a generator and an alternator; wherein the at least one of a generator and an alternator create an electrical current; wherein the case of a generator the AC current is converted to DC, such that the electrical current is DC. It is preferred that at least a portion of the electricity of electrolysis be generated from gas energy; wherein at least a portion of the gas is at least partially created by Infrared; wherein the Infrared is absorbed by at least a portion of an Aqueous Solution and H₂O; wherein, the at least a portion of the gas turns a turbine; wherein, the turbine turns at least one of a generator and an alternator; wherein the at least one of a generator and an alternator create an electrical current; wherein the case of a generator the AC current is converted to DC, such that the electrical current is DC; and wherein, at least a portion of the electrical current is the electricity of electrolysis.

It is a preferred embodiment that at least a portion of the electricity of electrolysis be generated by a Generator that is turned by a Hydrogen Engine of the instant invention. It is preferred that at least a portion of the electricity of electrolysis be generated by steam produced by a Combustion Chamber of the instant invention; wherein, the steam turns a steam turbine that turns a Generator to produce the electricity. Finally, it is preferred that at least a portion of the electricity of electrolysis be generated by a Generator that is turned by an expanding N₂ cryogenic gas; wherein, the N₂ cryogenic gas is created by cryogenic distillation of air; and wherein the cryogenic distillation of air is powered by rotating mechanical energy from at least one of a Hydrogen Engine of the instant invention or by steam created by a Combustion Chamber of the instant invention that drives a steam turbine to created rotating mechanical energy.

### Reforming

The instant invention comprises Reforming as Methane Reforming and Hydrocarbon Reforming to produce H₂ and CO₂. Reforming is endothermic. The instant invention comprises at least one of: Infrared from Sunlight, Wind and H₂ Energy as Means to provide heat to Reforming. In the case of Sunlight, Light Energy, it is preferred to use at least a portion of the light spectrum, Infrared, to heat H₂O and to use at least a portion of the energy of the heated H₂O to heat Reforming. In the case of Wind Energy, it is preferred to use electricity generated by a Wind Energy as energy to power a resistance heater to Reforming. In the case of H₂, it is preferred to combust the H₂ and use the heat of combustion of the H₂ to heat Reforming. It is an embodiment to combust CH₄ to directly or via Steam provide energy to Reforming. Reforming is that which is known in the art.

### Potential Energy/Fuel Generation

It is most preferred that at least a portion of the H₂ and/or O₂ from Electrolysis of H₂O and/or H₂ from Reforming in combination with O₂ from the 3d PBR be used in an engine using

H₂ as a fuel and O₂ as an oxidizer. It is most preferred that at least a portion of the H₂ and/or O₂ from Electrolysis of H₂O and/or H₂ from Reforming in combination with O₂ from the 3d PBR be used in an engine using H₂ as a fuel and O₂ as an oxidizer, wherein said engine is cooled by the addition of H₂O to the Combustion Chamber. It is most preferred that at least a portion of the H₂ and/or O₂ from Electrolysis of H₂O and/or H₂ from Reforming be used in an engine using H₂ as a fuel with air as the oxidizer, wherein said air is in excess over that required to perform combustion to limit combustion temperature and therefore NO_{X} formation.

### Hydrogen Engine

The Hydrogen engine of the instant invention manages energy much more efficiently than the traditional combustion engine, which operates with hydrocarbons and air. This is especially the case with respect to the internal combustion engine (ICE). ICE, generally, looses approximately 60 to 85 percent of available combustion energy in: heat losses from the engine, engine exhaust gases and unused mechanical energy. In contrast, the instant invention recaptures significant energy losses by converting lost energy (enthalpy and entropy) into potential energy and internal energy. Further, the instant invention generates additional power by utilizing steam to increase engine efficiency; while, using H₂O and/or steam to cool the engine. It is further discovered that the instant invention provides thermodynamic capability to improve combustion efficiency while providing improved engine performance; wherein, said improved engine performance relates to both produced engine power and available power produced per cubic inch of engine displacement.

Application preferably comprises energy of combustion of H₂ with O₂. Application also comprises combustion of H₂ with an excess of air over that required to perform combustion; such that, temperature of Combustion Chamber is reduced by the excess of air, thereby reducing and preferably minimizing NO_{X} formation. The combustion of H₂ with O₂ provides a combustion envelope having attributes which are somewhat different than those for any hydrocarbon. In comparison and contrast, the auto-ignition (combustion without a spark) temperature of H₂ is 585° C., while that of methane and propane is 540 and 487° C., respectively. The combustion envelope, by volume, for H₂ in air is near 4-75% (air is near 20% O₂), while that of methane and propane is near 5.3-15% and 2.1-9.5%, respectively. The explosive regions for H₂ and methane are 13-59% and 6.3-14%, respectively. Therefore, Application comprises a H₂ combustion envelope which allows for a cooling of Combustion Chamber and of combustion exhaust gases; wherein, said combustion envelope is not available with a hydrocarbon.

The combustion product of H₂ and O₂ is H₂O. This combustion reaction is somewhat similar to that of Hydrocarbon combustion; however, carbon (from Hydrocarbon) and nitrogen (from air) are removed from the reaction. The combustion of H₂ with O₂ produces H₂O, which is in stark contrast to the combustion of fossil fuels which in addition to H₂O produce CO_{X}, NO_{X} and whenever the hydrocarbon is contaminated with S, produce SO_{X}.

Application within the instant invention comprises the first and second laws of thermodynamics as an asset. In contrast, hydrocarbon combustion has the first and second laws of thermodynamics as a liability. Specifically, in combustion:

Combustion Energy=Available Work+Combustion Losses+Friction Energy Losses+Enthalpy Losses+Entropy Losses+Potential Energy,

which can be rewritten as:

Combustion Energy=Available Work+Combustion Losses+Friction Energy Losses+Heat and Cooling losses+Exhaust losses+Potential Energy,

And, in the case of most hydrocarbon combustion systems:

Combustion Energy=(15-20%)+(1-5%)+(5-15%)+≈35%+35% +0,

leaving only about 15 to 20% of combustion energy available for work.

In comparison and contrast, Application within the instant invention operates with conversion of Combustion Chamber enthalpy and recycling of exhaust gas energy, thereby redefining the thermodynamics of combustion, which is to be approximated by:

Combustion Energy (100%)=Available Work+Friction Energy Losses+Recycled Energy Losses+Potential Energy

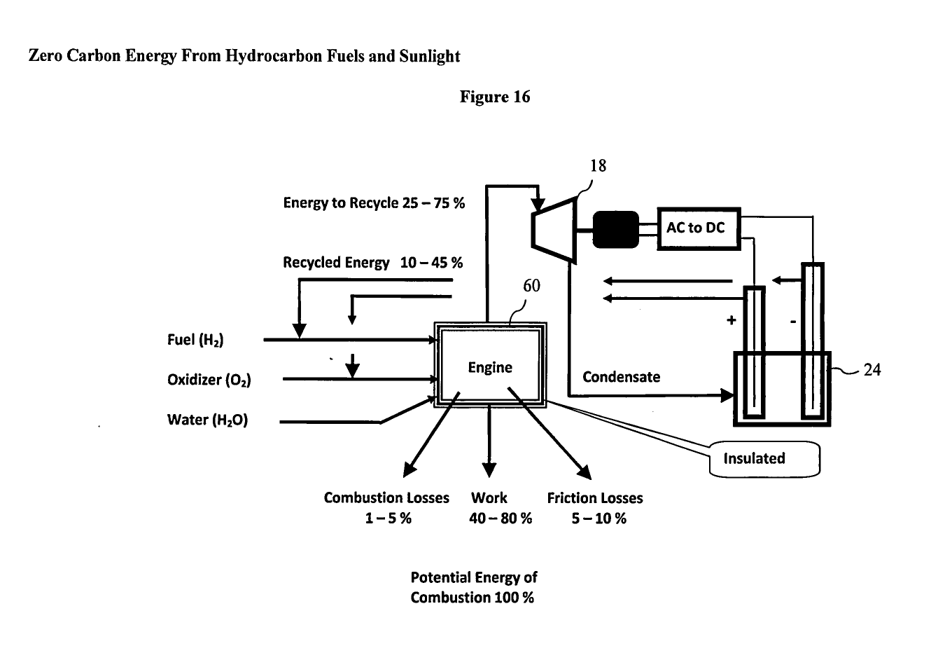

Therefore, 100% =(15 to 20%)+(1-5%)+(5-15%)+(5-40%)+Potential Energy. And, Potential Energy=25-75% excluding recycle losses, thereby producing an engine efficiency of about 40 to 80%, as presented in FIG. 16.

One embodiment increases concentration of O₂ in combustion; preferably while, reducing to eliminating N₂ in combustion so that effectiveness and efficiency of combustion is increased; as air, which is normally used as the oxidant in hydrocarbon systems, is only about 18-20% O₂ and about 80-82% N₂. Therefore and via increased concentration of O₂, discovered is significantly increased engine power per cubic inch of displacement (combustion volume). It is a preferred embodiment of Application to provide at least one of enriched, pure and very pure O₂ to combustion at a pressure of greater than 1 atmosphere absolute.

Instant invention power capability is enhanced by the discovered capability of the instant invention to provide at least one of H₂ and O₂ to combustion under pressure. This capability of the instant invention provides a significant power capability which is not practical in a hydrocarbon air induction combustion system. Specifically, a hydrocarbon air induction combustion system must increase rpm to increase power; as, the combustion chemistry is limited by availability of O₂ at atmospheric pressure. In contrast, the discovered instant invention can provide O₂, as well as H₂, to combustion under pressure. It is preferred to operate the instant invention; wherein, at least one of H₂ and O₂ is added to the Combustion Chamber at a pressure of greater than about 0.1 atmosphere (1 atmosphere=14.67 psia). It is preferred to operate the instant invention wherein at least one of H₂ and O₂ is added to the Combustion Chamber at a pressure of greater than about 1.0 atmosphere.

This discovered capability provides a significant power capability which is not practical in a hydrocarbon combustion system. Specifically, a hydrocarbon combustion system must increase rpm to increase power; as, combustion chemistry within each revolution is limited by the availability of O₂ in air at atmospheric pressure (or at a pressure slightly over that of atmospheric in the case of turbo-charging). In contrast, Application within the instant invention embodies providing at least one of enriched, pure and very pure O₂ to combustion at gauge pressure; wherein, said O₂ is preferably achieved from at least one of: cryogenic distillation, SA and membrane separation of air provides significantly increased O₂.

In another embodiment, the amount of air is increased to minimize combustion temperature, thereby minimizing formation of NO_{X}. The environmental consequences of combustion are minimized in combustion systems wherein an excess of air is required to reduce and/or control combustion temperature.

As the instant invention can operate “in diesel fashion” due to the auto-ignition temperature of H₂, which is near 585°C.; the discovered instant invention has the capability to further manage combustion energy by the addition of at least one of H₂ and O₂ during combustion. This discovered capability of the instant invention provides the ability of “a slow bum” during the power or expansion portion of the cycle. This slow bum capability of the instant invention is herein termed the “Newsom burn”. This improves the previously known Otto cycle by increasing available work, P×V.

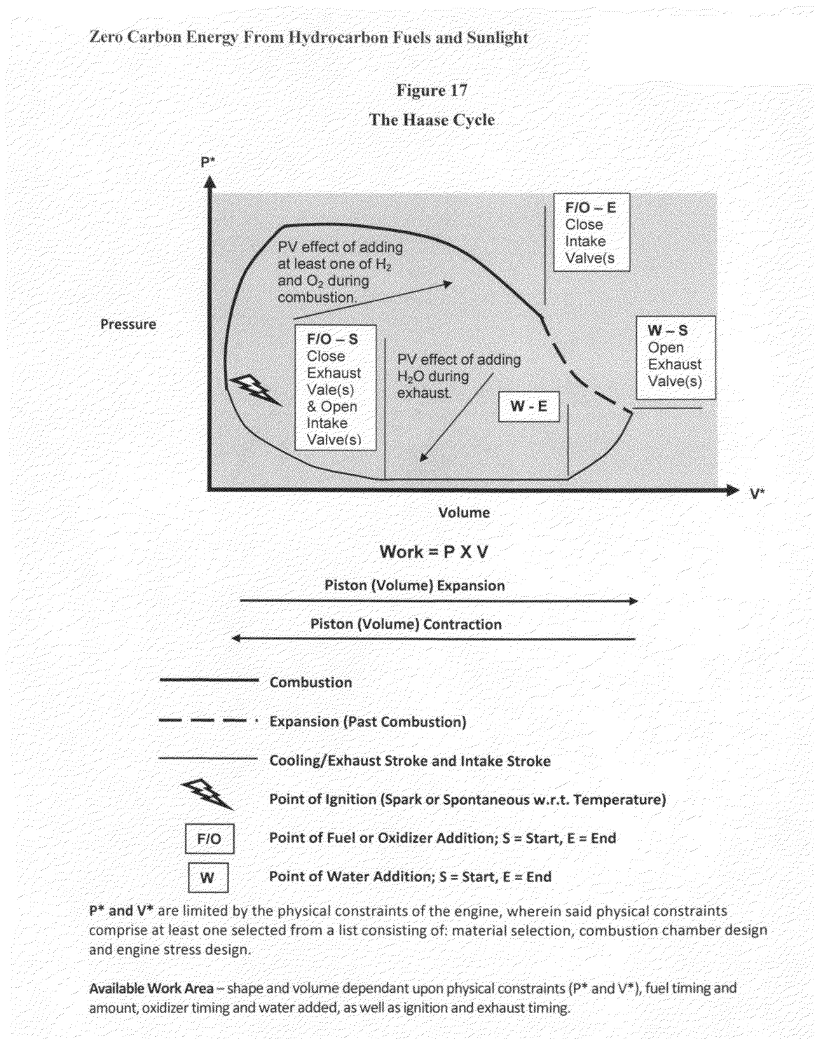

Capability of managing engine power by H₂O addition to cool the engine during the exhaust stroke as well as the capability of providing at least one of H₂ and O₂ to combustion during power generation (in the case of an ICE, this would be the power stroke and in the case of a turbine this would be anytime during the combustion of fuel); therefore, Application within the instant invention has capability of managing and/or manipulating the work (P−V) curves of an engine; such that, Application within the instant invention can manipulate the net work output for each engine cycle. Application variant to the Otto cycle incorporating H₂O cooling during exhaust and “Newsom burn” during power is defined in the instant invention defines a new combustion cycle termed the “Haase Cycle”, as depicted in FIG. 17.

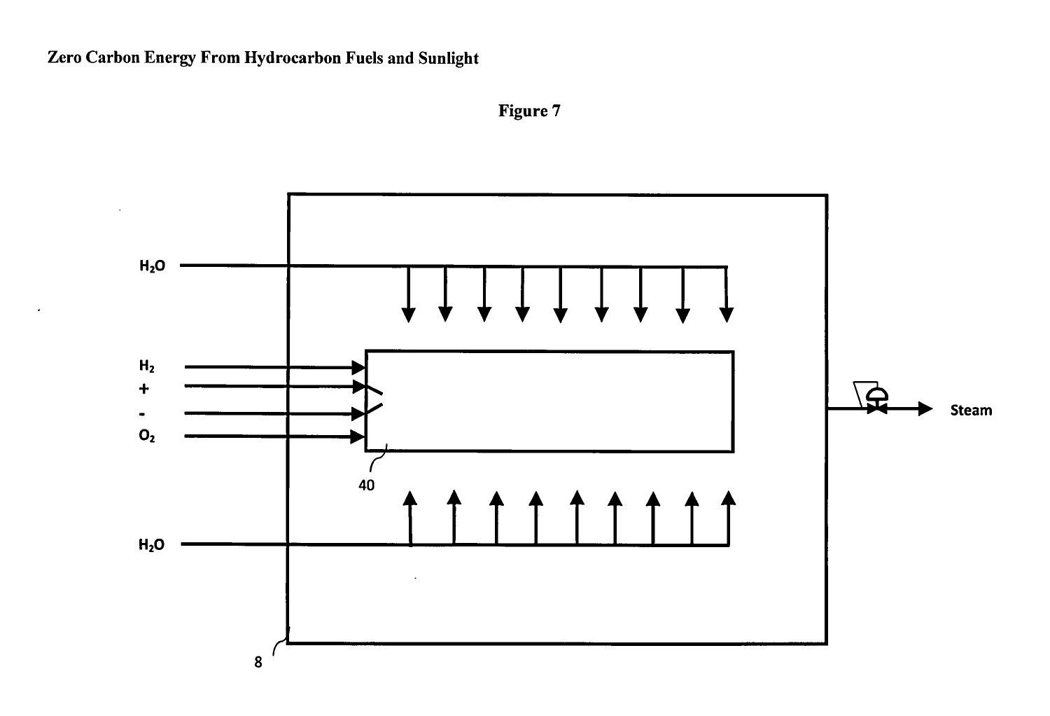

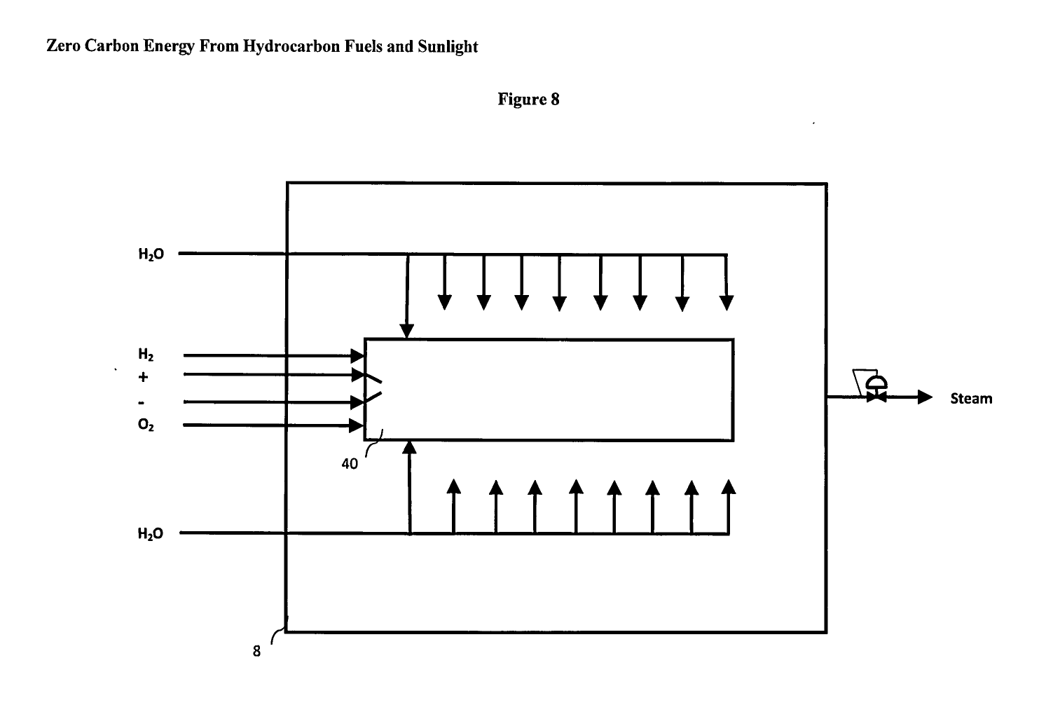

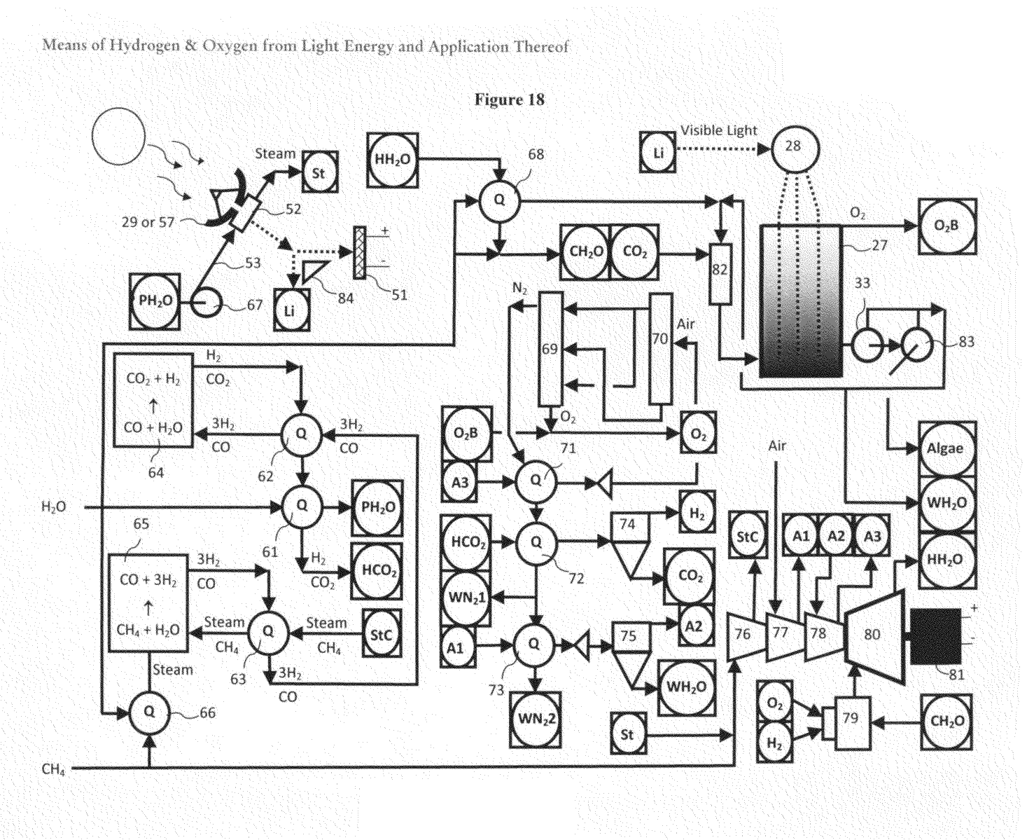

It is preferred to produce steam as depicted in FIGS. 7, 8 and 18. It is preferred to combust H₂ and O₂ in a Combustion Chamber and to further react produced H₂O with H₂O of a lower temperature than the flame temperature to produce steam. It is preferred to combust H₂ and O₂ in the presence of H₂O in a Combustion Chamber and then react the produced H₂O with H₂O of a lower temperature than the flame temperature to produce steam. It is preferred to combust H₂ and O₂ with H₂O in a Combustion Chamber with H₂O added to the Combustion Chamber and then react the produced H₂O from the Combustion Chamber with H₂O of a lower temperature that the flame temperature to produce steam. It is most preferred to combust H₂ and O₂ in the presence of H₂O in a Combustion Chamber such that the combustion temperature is less than the melting point of the material(s) of construction of the Combustion Chamber and then react the produced H₂O with H₂O of a lower temperature than the flame temperature to produce steam. It is preferred to combust H₂ and O₂ with H₂O in a Combustion Chamber with H₂O added to the Combustion Chamber such that the combustion temperature is less than the melting point of the material(s) of construction of the Combustion Chamber and then react the produced H₂O from the Combustion Chamber with H₂O of a lower temperature than the Combustion Chamber to produce steam.

It is preferred to operate the instant invention in the configuration of ICE, as is known in the art, wherein the instant invention operates with 2 cycles. It is preferred to operate the instant invention in the configuration of an internal combustion engine, as is known in the art, wherein the number of cycles is 4 or 5 or 6 or 7 or 8.

It is preferred that H₂ from at least one of Reforming and Electrolysis be combusted in the Hydrogen Engine to create rotating mechanical energy; wherein, the rotating mechanical energy turns a Generator; and wherein, the Generator creates electricity. It is preferred that O₂ from Natural Conversion and/or Electrolysis be used in the Hydrogen Engine, along with said H₂ from at least one of Reforming and Electrolysis. It is preferred that the Hydrogen Engine in electricity generation comprise turbine combustion; wherein, said turbine combustion engine create a portion of said rotating mechanical energy; and wherein, a steam turbine comprise steam from said turbine combustion engine and create a portion of said steam energy.

It is preferred that H₂ from Reforming and/or Electrolysis be used in the Hydrogen Engine to create rotating mechanical energy; wherein, the rotating mechanical energy moves a Transportation vehicle. It is preferred that the H₂ Engine in Transportation comprise pistons.

It is preferred that Means of the instant invention produce at least one selected from a list consisting of: rotating mechanical energy, power, torque, and any combination therein. H₂O is preferably added to the Combustion Chamber, while utilizing the steam (hot gaseous H₂O) produced during combustion and/or during cooling as a Means of further producing: rotating mechanical energy, power or torque; and, energy recycle by converting at least a portion of said steam energy into potential energy (fuel) for the instant invention.

Energy Recovery—Application furthers engine efficiency by adding H₂O to the Combustion Chamber at least once during at least one cycle to cool the engine, thereby creating steam while cooling the Combustion Chamber, and thereby further powering the engine. It is a preferred embodiment within an internal combustion engine to have at least one cycle wherein no fuel (H₂) or oxidizer (O₂) is added to the Combustion Chamber; wherein, H₂O is added as either a low pressure gas (steam) or as a liquid; wherein, the heat of the Combustion Chamber is transferred into said H₂O thereby cooling said Combustion Chamber and providing power due to the steam energy created by said heat transfer. It is a preferred embodiment within a turbine to add H₂O as either a low pressure gas (steam) or as a liquid to at least one of the Combustion Chamber and the steam turbine, wherein the heat of at least one of the Combustion Chamber and the combustion product (steam) is transferred into said H₂O, thereby cooling said Combustion Chamber and/or turbine; and thereby providing power due to the steam energy created by said heat transfer. The capability of Application to provide power and cooling by the addition of H₂O in at least one cycle other than the combustion cycle in an internal combustion engine or to provide further power and cooling by the addition of H₂O to at least one location in a turbine is herein defined as “Energy Recovery Cooling”. It is preferred that Energy Recovery Cooling approach adiabatic heat transfer as much as is practical.

It is an embodiment to perform cooling of the Combustion Chamber of the instant invention wherein H₂O in the form of at least one of a liquid and a gas is added to the Combustion Chamber at a time before or after combustion. In the case of a turbine, as a turbine spins within a housing comprising 360° and the flame of the Combustion Chamber is located within at least one point of said 360° of said combustion housing, said H₂O is preferably to be added to at least one point of said 360° of said combustion housing and in such an amount that said H₂O cannot extinguish combustion flame. In the case of ICE, it is preferred that said H₂O be added to the Combustion Chamber during a cycle in which combustion does not occur, thereby cooling said Combustion Chamber with said H₂O. (A cycle is herein defined as movement of the piston from top dead center (TDC) to full available piston displacement within the combustion cylinder and returning to TDC.) It is preferred to add said H₂O to the Combustion Chamber in an internal combustion engine during a cycle in which combustion does not occur; the latent heat of vaporization of H₂O is about 41 kJ/mole, as compared to the heat capacity of steam which is only about 34 J/(mole ° K.). It is most preferred to add said H₂O to the Combustion Chamber in ICE during a cycle in which combustion does not occur for a number of cycles to cool said Combustion Chamber; after which, a combustion cycle is repeated with H₂ and O₂. It is preferred that H₂O added to the combustion cylinder as near the beginning of the cycle (TDC) as is practical. Available work from steam and the available cooling of the cylinder from adiabatic expansion of steam are directly related to the amount of adiabatic expansion of said steam in combination with the beginning temperature of said steam and the amount of said steam. It is preferred that there be at least one cycle in which H₂O is added to the Combustion Chamber. The number of cycles adding H₂O to the Combustion Chamber prior to the next combustion cycle is limited by available enthalpy (measured as temperature) in the Combustion Chamber from the previous combustion cycle and the cooling effect of steam upon the cylinder during adiabatic expansion of said steam. Depending on the combustion chamber temperature, the amount of H₂O converted to steam and the amount of adiabatic expansion, it is an embodiment for a number of cycles of Energy Recovery Cooling, wherein said number can be from 1 to 10. It is preferred that H₂O is added to the Combustion Chamber during at least one cycle or operating time wherein combustion is not performed and the H₂O absorbs enthalpy from the Combustion Chamber, thereby creating steam energy and cooling the Combustion Chamber.

It is preferred that the Hydrogen Engine be insulated. It is most preferred that said insulation be that as is known in the art. It is preferred that said insulation be located around each Combustion Chamber to thereby minimize the use of high temperature materials in construction of the Hydrogen Engine. In the case of an ICE, it is preferred that each Combustion Chamber (most likely of cylinder type design) be insulated with insulation materials as known in the art of insulation. In the case of an ICE, it is preferred that each Combustion Chamber (most likely of cylinder type design) be insulated with insulation materials as known in the art of insulation; wherein, said insulation materials slow the rate of heat transfer from said Combustion Chamber which at least partially surrounds said Combustion Chamber. In the case of an ICE, it is preferred that each Combustion Chamber (most likely of cylinder type design) be insulated with insulation materials as known in the art of insulation, wherein the piston contains a layer of insulation to reduce the rate of heat transfer from the Combustion Chamber into the block of the engine. In the case of an ICE, it is preferred that each Combustion Chamber (most likely of cylinder type design) be insulated with insulation materials as known in the art of insulation, wherein the head components of said ICE comprise a layer of insulation to reduce the rate of heat transfer from the Combustion Chamber to said head components or to the surrounding environment. In the case of an ICE, it is preferred that each Combustion Chamber (most likely of cylinder type design) be insulated with insulation materials as known in the art of insulation; wherein, said ICE is cool to the touch. In the case of an ICE, it is preferred that each Combustion Chamber (most likely of cylinder type design) be insulated with insulation materials as are known in the art of insulation; wherein, the external surface temperature of said ICE is at least about less than 150° F. In the case of a turbine, it is preferred that each Combustion Chamber (most likely of cylinder type design) be insulated with insulation materials as are known in the art of insulation.

It is an embodiment that materials of construction of the Combustion Chamber have a high heat transfer coefficient, such as that which is available with metals. Energy Recovery Cooling is most effective when the energy contained within the Combustion Chamber is easily transferred to the H₂O, thereby creating steam energy during Energy Recovery Cooling. It is an embodiment that the materials of construction of the Combustion Chamber have a relatively high heat capacity, such as that which is available with metals. As the Combustion Chamber of the internal combustion engine is inherently inefficient loosing near 50 to 80 percent of the energy of combustion to heat and exhaust gases, Energy Recovery Cooling can most effectively improve engine power and efficiency when combustion heat energy, enthalpy, from the previous combustion cycle is stored within the material(s) of construction of the Combustion Chamber.

It is preferred to electro-chemically convert H₂O into O₂ and H₂. It is to be understood that under the best of engineered circumstances, the electrical energy required by electrolysis to convert H₂O into O₂ and H₂ will be greater than the energy obtained by the combustion of O₂ and H₂. However, electrolysis allows for significant improvements in the thermodynamic efficiency of combustion by reclaiming energy which would otherwise be lost.

As the installation of a steam turbine in the engine exhaust will create a back pressure situation to the engine, thereby lessening engine power and efficiency, it is preferred that the instant invention include a condenser, thereby evacuating the Combustion Chamber and minimizing Combustion Chamber pressure prior to the next combustion cycle. It is most preferred that the condenser for steam exiting the steam turbine and the condenser for the steam evacuating the Combustion Chamber be the same condenser. It is an embodiment that the condenser for steam exiting the steam turbine be separate from the condenser for the steam evacuating the Combustion Chamber. It is preferred that make-up H₂O to the instant invention be added to at least one of said condenser(s). It is preferred that the H₂O added to the Combustion Chamber comprise H₂O from said condenser(s). It is preferred that at least a portion of the H₂O in said condenser(s) be transferred to an electrolysis unit. It is preferred that the H₂O in said electrolysis unit be converted to H₂ and O₂ by electrolysis. It is preferred that at least a portion of said H₂ be used as a fuel in said Combustion Chamber. It is preferred that at least a portion of said O₂ be used as an oxidizer in said Combustion Chamber. It is most preferred that the electrical energy of said electrolysis unit be obtained from at least one Generator; wherein, the power to turn said Generator be obtained from at least one selected from a list consisting of: a steam turbine turned by the exhaust gases (steam) from the Combustion Chamber(s), a drive shaft turned by the Combustion Chambers, moving wind energy, moving H₂O energy, and any combination therein.

It is preferred to obtain the electrical energy for electrolysis from rotating mechanical energy turning a Generator and exhaust gas steam energy turning turbine which turns a Generator. It is most preferred that said rotating mechanical energy comprise rotating mechanical energy created by an engine using H₂ as a fuel and O₂ as an oxidizer. It is most preferred that said rotating mechanical energy comprise rotating mechanical energy created by an engine using H₂ as a fuel and O₂ as an oxidizer, wherein said engine is cooled by the addition of H₂O to the Combustion Chamber.

It is most preferred that at least a portion of the H₂ and/or O₂ from the electrolysis of H₂O be used in an engine using H₂ as a fuel and O₂ as an oxidizer. It is most preferred that at least a portion of the H₂ and/or O₂ from the electrolysis of H₂O be used in an engine using H₂ as a fuel and O₂ as an oxidizer, wherein said engine is cooled by the addition of H₂O to. the Combustion Chamber.

It is preferred to generate electrical energy, wherein said electrical energy (electricity) is created from a Generator; wherein, said Generator is turned by rotating mechanical energy; wherein, said rotating mechanical energy is created by the Hydrogen Engine. It is preferred to generate electricity, wherein said electricity is created from a Generator, wherein said Generator is turned by rotating mechanical energy; wherein, said rotating mechanical energy is created by the Hydrogen Engine.

It is a preferred embodiment that said rotating mechanical rotating energy enter a transmission, wherein said transmission engage in a manner that is inversely proportional to the torque and/or work load of the engine, wherein said transmission output mechanical rotating energy turn said Generator to create said electrical energy. Said transmission is to be as is known in the art. It is most preferred that said transmission engage a flywheel capable of storing rotational kinetic energy, wherein said flywheel turns said Generator.

It is preferred to generate electricity, wherein electricity is from a Generator; wherein, the Generator is turned by a steam turbine; wherein, the steam turbine is turned by steam, wherein the steam is created by the Hydrogen Engine. It is preferred to generate electricity; wherein, the electricity is from a Generator; wherein, the Generator is turned by a steam turbine; wherein, the steam turbine is turned by steam; wherein, the steam is created by the Hydrogen Engine; wherein, the Hydrogen Engine is cooled by the addition of H₂O to the Combustion Chamber. It is preferred that the steam turbine(s) be in such a configuration that the steam be the exhaust of the hydrogen engine. It is preferred that said steam energy be converted into rotational mechanical energy via a turbine to turn said Generator. It is most preferred that there be at least one steam turbine and that the steam turbine(s) create mechanical energy to turn at least one of said Generator(s).

Cryogenic Distillation—It is an embodiment to separate air into at least one of O₂ and N₂. It is preferred in addition to separate H₂, to fuel the combustion of O₂ with H₂; and to, utilize the energy of the combustion of H₂ with O₂ to power cryogenic distillation of air. It is an embodiment to use distilled N₂ and/or Ar as a heat sink. This heat sink is preferably utilized to perform at least one selected from a list consisting of cool the storage of O₂, cool the storage of H₂, facilitate the process of cryogenic distillation, cool the engine, provide refrigeration, provide environmental cooling, provide an energy source to turn a turbine generating electricity and any combination therein. In the case of the internal combustion engine, this heat sink is preferably used at least partially in place of the engine H₂O coolant cooling system (typically a fan cooled radiator). A preferred use of said distilled N₂ and/or Ar would be to allow said N₂ and/or Ar to warm and thereby expand so as to be available as an energy source to drive a turbine to generate electricity and/or to create mechanical energy. Further, the distillation of Ar from N₂ is immaterial except as a combustion efficiency improvement; the additional fractionating column to separate Ar and/or N₂ from O₂ should be viewed on a capital investment—efficiency rate of return analysis.

It is preferred to power the instant invention Application cryogenic air separation Means with at least one of rotational mechanical energy and electricity. It is preferred that at least a portion of said rotational mechanical energy and/or electricity be generated by the Hydrogen Engine. It is preferred that at least a portion of said rotational mechanical energy or electricity be generated by the Hydrogen Engine; wherein, combustion is cooled by the addition of H₂O to the Combustion Chamber. It is preferred that at least a portion of said rotational mechanical energy or electricity be generated by the Hydrogen Engine; wherein, the air is in excess over that required to perform combustion to limit NO_{X} formation. It is preferred that said cryogenic distillation separate H₂.

Cryogenic Storage of H₂ and/or O₂—It is preferred to store at least one of O₂ and H₂ at a temperature of less than 0° C., herein referred to as cryogenic O₂ and cryogenic H₂, respectively. It is preferred to utilize cryogenically available N₂ or Ar (from air separation) to cool the O₂ and/or the H₂ to a temperature of less than 0° C. It is a preferred embodiment to utilize cryogenically available N₂ or Ar (from air separation) to cool the H₂ to a temperature at which said H₂ has a positive JtC. It is a most preferred embodiment to utilize cryogenically available N₂ or Ar (from air separation) to cool the H₂ to a temperature at which said H₂ has a positive JtC; wherein, the H₂ is cooled by a refrigeration loop utilizing at least one of H₂, N₂ and Ar as the refrigerant. It is preferred that the refrigeration loop be powered by at least one of: the engine, expansion of cryogenically available N₂ or Ar, and an outside source of electricity. It is a most preferred embodiment to utilize cryogenically available N₂ or Ar (from air separation) to cool the H₂ to a temperature at which said H₂ has a positive JtC; wherein, the H₂ is cooled by a refrigeration loop utilizing at least one of H₂, N₂ and Ar as the refrigerant; and wherein, the H₂ is stored at a temperature of about less than 100° K. It is most preferred to use the cryogenic N₂ or the N₂ still chilled to chill or cool at least one of: air, H₂O, H₂, O₂, a freon, CO₂, and any combination therein. Given a JtC of nar 1.25, CO₂ is a good refrigerant. (Freon is defined as any chlorinated and fluorinated carbon molecule; wherein, the number of carbon atoms is 4 or less.)

Membrane Separation—Membrane separation is a preferred method of obtaining at least one of enriched, pure and very pure O₂. It is most preferred that membrane separation be performed wherein there is an electrical current provided across the membrane to assist in the separation of air into at least one of enriched, pure and very pure O₂.

SA—At least one of PSA and VSA separation of air is a preferred embodiment to obtain at least one of enriched, pure and very pure O₂. PSA and VSA (“SA”) have the same drawback as membrane separation, as compared to cryogenic distillation of air; as, N₂ is not be available as a heat sink, as when ifrom cryogenic distillation of air.

Aqueous Absorption—The instant invention embodies incorporating CO_{X} and NO_{X} into an aqueous phase. The instant invention embodies the water absorption characteristics of CO_{X} and/or NO_{X}. The instant invention further embodies combining at least one of CO_{X} and NO_{X} into metal salt(s), preferably into a Group IA or Group IIA metal salt, most preferably into a salt comprising at least one of sodium, magnesium or calcium. The instant invention further also embodies the affinity that a metal, preferably a Group IA metal or Group IIA metal, and most preferably at least one of sodium, magnesium or calcium, has for carbonate anions. The instant invention also further embodies the insolubility characteristics of a metal, preferably a Group IA IIA metal, most preferably at least one of sodium or calcium with carbonate, whether as a hydrate or in an anhydrous form. The instant invention further still embodies the anti-agglomeration characteristics of a dispersant in combination with a metal-CO₃ or metal-NO₂ or metal-NO₃ in aqueous solution.

The instant comprises invention inexpensively and safely removes at least one of CO_{X} and NO_{X} from a gas. In a preferred embodiment, at least a portion of the CO_{X} and/or NO_{X} is absorbed into an aqueous phase; wherein, at least a portion of the CO_{X} and/or NO_{X} is reacted with a metal salt. It is preferred that the metal salt be added to the aqueous phase as at least one selected from the group consisting of: calcium sulfate, calcium sulfate ½ hydrate, calcium sulfate hydrate, calcium sulfate di-hydrate, and any combination therein.

It is most preferred that the adsorption comprise a dispersant in the aqueous phase. It is most preferred that the adsorption comprise a dispersant in the aqueous phase such that precipitation of the metal carbonate and/or metal nitrate is reduced.

It is most preferred that the asdorption occur in a contact tower with countercurrent flow of the CO_{X} and/or NO_{X} to the aqueous phase. It is most preferred that the adsorption tower comprise contact media, such that the contact media improve adsorption of the CO_{X} and/or NO_{X} into the aqueous phase.

It is most preferred that the adsorption occur under pressure. It is most preferred that the adsorption occur under a pressure of 1 to 100 atmosphere. It is most preferred that the adsorption tower comprise a pressure of 1 to 100 atmosphere.

### Photo-Bio-Reactor (“PBR”)

The instant invention preferably comprises a PBR comprising Means of Natural Conversion. PBR Means preferably comprises CO₂ from Reforming as a raw material or food (substrate) in Natural Conversion. PBR Means preferably comprises at least one of carbonate and CO₂ as a raw material or food (substrate) in Natural Conversion. PBR Means comprises gas membrane distribution Means so that the CO₂ is dispersed in an aqueous phase within the PBR. Natural Conversion in PBR Means preferably converts at least one of carbonate and CO₂ into O₂ and Living Matter. PBR Means preferably has Means of O₂ capture from the Natural Conversion; such that, the O₂ can be used in said Hydrogen Engine to create electricity.

Said PBR Means is preferably to comprise Means of light (photon) collection and transfer so that light is transmitted within said PBR Means and said PBR Means comprises a aqueous depth of Natural Conversion greater than about one (1) meter. Said light transfer is preferably to comprise Means of heat transfer from the collected light; so that, temperature within said PBR is maintained. It is preferred that said heat transfer comprise the transfer of Infrared from the light to Reforming; such that, the endothermic requirement of the Reforming is at least partially met by the heat transfer. It is most preferred that said heat transfer, Infrared, be performed via a heat exchange or a Light Energy Reaction Chamber to an Aqueous Solution and that at least a portion of energy of the Aqueous Solution be transferred to said Reforming.

It is most preferred that said Natural Conversion comprise algae. Algae assimilate soluble CO₂ and/or carbonate and/or NO_{2 or 3} and not gaseous CO₂ and/or NO_{2 or 3}; therefore, PBR Means is constrained by the water solubility kinetics of CO₂ and/or NO_{2 or 3} water absorption. As the absorption by algae of Visible is limited by aqueous phase penetration depth, which depends on the genus and specie of algae as well as, algae concentration, PBR Means is constrained by algae specie, the depth and concentration of algae in water. Most importantly, as algae only grow with availability of photons, PBR Means is constrained by Visible availability. As algae grow in relation to the Arrhenius Relationship, e.g. an about doubling of temperature corresponding to an about doubling of activity, temperature is a significant PBR operating parameter. As algae growth slows with increasing O₂ concentration in water, O₂ concentration is a parameter in PBR Means. As algae require an operating pH range, pH is a parameter for PBR Means. As algae require a source of Total Organic Carbon (TOC), soluble TOC is a parameter for PBR Means. As algae require nutrients, the concentration of nutrients is a parameter for PBR Means.

It is an embodiment that the PBR comprise algae. It is preferred that the algae in the PBR comprise at least one algae selected from the group consisting of: Anabaena cylindrical, Bostrychia scorpioides, Botrycoccus braunii, Chaetoceros muelleri, Chlamydomonas moeweesi, Chlamydomonas reinhardtii, Chlorella pyrenoidosa, Chlorella vulgaris, Chlorella vulgaris Beij, Dunaliella bioculata, Dunaliella salina, Dunaliella tertiolecta, Euglena gracilis, Isochrysis galbana, Isochrysis galbanais micro, Nannochloris sp., Nannochloropsis salina, Nannochloropsis salina Nannochloris oculata—N. oculata, N. atomus Butcher, N. maculata Butcher, N. gaditaa Lubian, N. oculata, Neochloris oleoabundans, Nitzschia communis, Parietochloris incise, Phaeodactylum tricornutum, Pleurochrysis carterae, haptophyta, prymnesiophyceae, Porphyridium cruentum, Prymnesium parvum, Scenedesmus dimorphus, Scenedesmus obliquus, Scenedesmus quadricauda, Schenedesmus dimorphus, Spirogyra sp., Spirulina maxima, Spirulina platensis, Spirulina sp., Synechoccus sp., Tetraselmis chui, Tetraselmis chui, Tetraselmis maculate, Tetraselmis suecica, Botrycoccus braunii, and any combination therein. It is most preferred that the algae in the PBR be at least one algae selected from the group consisting of Botryococcus braunii strains, Chlamydomonas reinhardtii, Chlorella vulgaris, Anabaena cylindrical, Chlamydomonas rheinhardii, Chlorella pyrenoidosa, Chlorella vulgaris, Dunaliella bioculata, Dunaliella salina, Euglena gracilis, Porphyridium cruentum, Prymnesium parvum, Scenedesmus dimorphus, Scenedesmus obliquus, Scenedesmus quadricauda, Spirogyra sp., Spirulina maxima, Spirulina platensis, Synechoccus sp., Tetraselmis maculate, and any combination therein.

It is preferred that the algae comprise at least one of: non-pathogenic, non-opportunistic, low-virulence factor, and any combination therein. It is an embodiment that the algae be mutant.

It is an embodiment that the PBR have a photon penetration depth within the aqueous phase to the algae of 100 cm or less. It is preferred that the PBR have a photon penetration depth within the aqueous phase to the algae of 10 cm or less. It is a most preferred embodiment that the PBR have a photon penetration depth within the aqueous phase to the algae of 5 cm or less. It is most preferred that the algae in the PBR have a reduced chlorophyll content so as to improve photon (light) penetration in the PBR. It is preferred that the photon concentration in the PBR is greater than 10 W/m² and equal to or less than the Photo-toxicity point for at least one specie of algae in the PBR. It is an embodiment that the photo-period comprise a time of light and dark which is 20 hours of light and 4 hour of dark to 4 hours of light and 20 hours of dark. It is preferred that the photoperiod comprise 12 hours of light and 12 hours of dark.

It is preferred that at least a portion of the CO₂ is in aqueous solution in the PBR. It is most preferred that the CO₂ is supplied to the aqueous solution in the PBR from the Reformer. It is preferred that CO₂ is supplied to the PBR as a gas. It is preferred that the CO₂ be supplied to the PBR as a mixture with air. It is preferred that the CO₂ be introduced into the PBR via Means to reduce or minimize bubble size. It is most preferred that the CO₂ be introduced into the PBR via a membrane type of material, as is known in the art. It is preferred that the CO₂ be dispersed in the PBR via a tube made of a membrane type material, as is known in the art of gas transfer. It is preferred that the CO₂ be dispersed in a PBR via a tube comprising holes (gas tube). It is preferred that the CO₂ be dispersed in a PBR via a gas tube, wherein the gas tube comprises a membrane type material, such that the CO₂ is forced through the membrane material into the aqueous phase. It is preferred that the CO₂ be dispersed in a PBR via a tube made of membrane type material or a gas tube surrounded by membrane type material and that the CO₂ and tube sizing be such that CO₂ pressure within the tube can be managed. It is most preferred that the CO₂ pressure within the tube be about the same from end to end. It is most preferred that the membrane of the gas tube be such that CO₂ flow into the aqueous solution is about the same from end to end and regardless of water depth and/or pressure. It is most preferred that the membrane of the tube be such that the holes for CO₂ into the aqueous solution are sized so as to about compensate for hydrostatic pressure within the aqueous phase such that CO₂ is about the same from end to end and regardless of water depth and/or pressure. It is most preferred that the tube be coaxial to and within a PBR, wherein the PBR comprises a tubular shape.

It is preferred that the CO₂ introduced into the PBR be introduced into the PBR in a pattern so as to minimize shearing of the algae within the PBR while providing mixing of PBR contents. It is preferred that the CO₂ introduced into the PBR be introduced into a tubular shaped PBR in a manner consistent with the size of the PBR to create mixing of the aqueous solution within the

PBR. It is most preferred that the mixing transfer algae to and from the side of the PBR nearest the source of light to the PBR. It is preferred that the CO₂ introduced into the PBR be introduced into the PBR in a manner consistent with the size of the PBR to create turbulent flow of the aqueous solution within the PBR. It is most preferred that the CO₂ introduced into a tubular PBR be introduced in a location within the PBR such that the Means of CO₂ introduction minimally inhibits photon transfer in the aqueous phase. In the case of a tubular PBR, it is preferred that a tubular membrane be used to introduce the CO₂ and that the tubular membrane be located on the wall of the tubular PBR. In the case of a tubular PBR wherein the photon tube is in the center of the PBR, it is most preferred that the gas tube encircle the photon tube on the wall of the tubular PBR from a beginning point located on one side of the center of the length of the tubular PBR to another point on the other side of the center of the length of the tubular PBR. It is most preferred that said beginning point be near one end of the tubular PBR. It is most preferred that said another point be near the opposite end of the tubular PBR from beginning point. In the case of a Continuous Stirred Tank Reactor (CSTR) PBR, CO₂ may enter the CSTR at any location, be that in or near the base, from or near the walls, via tubes or media in the aqueous solution.

It is preferred that the PBR be made of tubular construction. It is preferred that there be a number of tubular PBR(s). It is preferred that the PBR(s) be of tubular shape and comprise a diameter of 5 cm or less. It is preferred that the PBR(s) comprises at least one of: silicon, glass, carbonate, a conductive material, metal, and any combination therein. It is most preferred that the tubular PBR be of annular construction such that the PBR is a tube within a tube, wherein the photons enter the PBR via the center tube and the PBR aqueous solution comprise the annulus or radii between the outer tube and the inner tube.

It is most preferred that CO₂ be introduced to the PBR in the form of at least one of soluble CO₂ and carbonate in aqueous solution. It is most preferred that CO₂ be introduced to the PBR in the form of at least one of soluble CO₂ and carbonate in aqueous solution, wherein the at least one of soluble CO₂ and carbonate in aqueous solution be formed in an absorption column or tower. It is most preferred that CO₂ be introduced to the PBR in the form of at least one of soluble CO₂ and carbonate in aqueous solution, wherein the at least one of soluble CO₂ and carbonate in aqueous solution be formed in an adsorption tower, and wherein the adsorption tower comprise contact media.

It is most preferred that the PBR operate under pressure. It is most preferred that the PBR comprise a pressure of 1 to 100 atmosphere.

It is most preferred that the PBR be of 3d and CSTR Design. It is most preferred that the CSTR 3d PBR comprise a number of photon tubes. It is most preferred that photon tube spacing in the CSTR 3d PBR be such that light (photons) may penetrate the aqueous phase to the algae. It is most preferred that the CO₂ introduction to a CSTR 3d PBR be such that mixing of the aqueous phase is maintained. It is preferred that the CO₂ introduction to a CSTR 3d PBR be such that mixing of the aqueous phase is maintained such that the concentration of CO_{X} at any vertical level in the CSTR 3d PBR not vary by more than 50 percent. It is most preferred that the CO₂ introduction to a CSTR 3d PBR be such that mixing of the aqueous phase is maintained such that the concentration of CO_{X} at any vertical level in the CSTR 3d PBR not vary by more than 25 percent. It is an embodiment that the photon tube(s) in a CSTR 3d PBR be no more than 100 cm apart. It is preferred that the photon tube(s) in a CSTR 3d PBR be no more than 30 cm apart. It is most preferred that the photon tube(s) in a CSTR 3d PBR be no more than 10 cm apart.

It is preferred that the PBR(s) be made of a translucent material. It is preferred that the PBR(s) material of construction comprise Silicon. It is preferred that the PBR(s) material of construction comprise glass. It is preferred that the PBR(s) material of construction comprise carbonate. It is preferred that the PBR(s) material of construction comprise a metal so that an electric charge may be placed upon the wall of the PBR(s). It is most preferred that an electric charge be placed upon the wall surface of the PBR(s) thereby creating a zeta potential on the wall surface of the PBR(s) to reduce algal tackification to the wall surface of the PBR(s). It is preferred that the PBR(s) have a Means of vibration. It is preferred that the PBR(s) have a Means of vibration to reduce algal tackification to the wall surface of the PBR(s). It is preferred that the PBR(s) comprise a Means of ultrasonics as a Means to reduce algal tackification to the wall surface of the PBR(s), as well as reduce algae agglomeration. In the Means of ultrasonics, it is most preferred that at least one of the ultrasound amplitude and frequency be limited so that the energy of ultrasonics does not affect algae cell viability.

It is an embodiment that light be made available to the PBR(s). It is preferred that light be transferred via at least one mirror to the PBR(s). It is most preferred that light be concentrated and transferred via at least one mirror to at least one PBR(s).

It is preferred that at least one photon (light) Collector concentrate light as is known in the art. It is preferred that the light collector(s) have an ability to track the Sun or change position so as to maintain an optimum position of photon collection in relation to the position of the sun, as is known in the art of light collection. It is preferred that the light Collector comprises at least one reflective or mirrored surface. It is preferred that the light Collector be of dish type design concentrating light to the focal point of the dish, as is known in the art of light collection. It is preferred that the light from a number of light Collectors be transferred to a distribution point, wherein from the spherical shaped distribution point light is transferred to at least one PBR. It is preferred that the distribution point comprise a spherical shape. It is preferred that the distribution point comprise a mirrored surface. It is preferred that the Means of transfer be of tube shape, wherein the inside surface of the tube comprises a reflective or mirrored surface so as to reflect light (photons). It is preferred that the mirrored tube(s) transfer photons down the inside of the tube to at least one PBR. It is preferred that said tube comprise a pressure of less than 1 atmosphere. It is most preferred that the light be placed in a fiber optic cable, as is known in the art, for transfer of the light to at least one PBR. It is preferred that the fiber optic cable comprise a reflective or mirrored surface so as to reflect light. It is preferred that an ultraviolet light filter reduce at least a portion of the ultraviolet light from the concentrated light prior to transfer to at least one PBR. It is preferred that the concentrated light be separated so as to emit into at least one PBR.

It is preferred that at least a portion of the hydrocarbon product of the algae or at least a portion of the algae itself from within at least one PBR be used to generate electrical energy. It is preferred that at least a portion of the hydrocarbon product of the algae or at least a portion of the algae itself from within at least on PBR be used to generate electrical energy and that at least a portion of the electrical energy be used to produce photons for at least one of the PBR.

It is preferred that light (photons) be emitted upon and into at least one PBR. It is preferred that photons be placed upon a number of PBR. It is preferred that light be placed upon a number of tubular PBR such that the tubular PBR are arranged around the placement of light (this is termed herein as a PBR Cluster). It is preferred that a PBR Cluster be arranged such that the PBR(s) in the PBR Cluster are side-by-side and not end-to-end so as to form around the placement of light. It is preferred that the placement of light be within a cylinder or tube (herein after a cylinder or tube transferring photons among and to the PBR(s) is termed a photon tube).

It is preferred that the PBR Cluster comprise the photon tube in the center, wherein photons are distributed to the PBR(s). It is preferred that a number of PBR and photon tube be arranged such that there is two PBR between each of two photon tubes. It is preferred that the photon tube comprise a translucent material and comprise at least one of: a one way mirror at one end, the one way mirror allowing photon entrance into the photon tube while reflecting photons from leaving the same end, and a reflective or mirrored surface at the end opposite the end of photon entrance. It is an embodiment that the PBR Cluster comprise space between the PBR(s), wherein the space between the PBR(s) allows photons from the photon tube to pass between the PBR(s), such that the photons which pass between the PBR(s) are reflected from a reflective or mirrored surface onto the side of the PBR(s) which does not face the photon tube. It is preferred that the PBR Cluster comprise at least one of: a one way mirror at one end, the one way mirror allowing photon entrance into the PBR Cluster while reflecting photons from leaving the same end, a reflective or mirrored surface at the end opposite the end of photon entrance, and a conical shaped reflective or mirrored surface at the end opposite the end of photon entrance.

It is most preferred that the photon tube comprise a fiber optic cable.

It is preferred that the number of PBR in a PBR Cluster be between 4 and 12. It is most preferred that the number of PBR in a PBR Cluster be 6. It is most preferred that the diameter of the tubular PBR and the diameter of the photon tube be about the same. It is preferred that there be a number of PBR Cluster. It is most preferred that the number of PBR Cluster be placed side-to-side so as to form a hexagonal honeycomb shape when viewed from the end.

It is an embodiment that photons be placed between the PBR tubes forming the PBR Cluster, wherein the photons are released into one end of the PBR Cluster between the PBR(s). It is an embodiment that the photons placed between the PBR tubes forming the PBR Cluster at one end of the PBR Cluster, wherein a reflective or mirrored surface is located at the opposite end of the PBR Cluster. It is preferred that the reflective or mirrored surface be conical in shape.

It is most preferred that each PBR Cluster or a number of PBR Cluster be at least partially enclosed in a reflective or mirrored Means to reflect (photons) light from or near the PBR(s) into the PBR(s).

It is preferred that a number of PBR Cluster be located in a unit or apparatus.

It is preferred that a number of CSTR PBR be located in a unit or apparatus.

For assembly and/or maintenance purposes, it is preferred that each PBR comprise Means of PBR removal from a unit comprising at least one PBR, wherein the at least one PBR comprise a Means of sealing the inflow or outflow of at least one of the aqueous solution and the CO₂, as needed. It is preferred that each PBR(s) within a PBR Cluster comprise a Means of removal and replacement. It is most preferred that the PBR(s) comprise a sealing of at least one of the inflow gas and inflow aqueous solution, and a sealing of the outflow aqueous solution, such that the PBR is easily removed and replaced.

It is preferred that there be placed within at least one PBR a Means of measuring light intensity, as is known in the art of light measurement. It is most preferred that the amount of light within a PBR be between 10 W/m² irradiance and Photo-toxicity for an algae within the PBR. It is preferred that a control loop be placed within the light transfer Means so as to obtain an input signal from the light intensity measuring Means and reduce or filter light to the PBR when light intensity is near Photo-toxicity for an algae within the PBR.

It is an embodiment that temperature within the PBR(s) is between 17 and 70° C. It is preferred that the temperature within the PBR(s) is within a 5° C. range of temperature, wherein the 5° C. range of temperature is between 17 and 70° C. It is preferred that the PBR(s) be insulated from ambient temperature with the materials of insulation as is known in the art of insulation. It is most preferred that each PBR Cluster or number of PBR Cluster in a unit be insulated from the ambient temperature with materials of insulation as is known in the art of insulation. It is preferred that a temperature sensor be located within at least one PBR or PBR Cluster to measure the water temperature either just before each PBR, within each PBR or after each PBR. It is preferred that at least one of a water cooling or a water heating device, as is known in the art of water heating and cooling, be placed so as to perform at least one of heating and cooling of the water entering at least one PBR or PBR Cluster. It is most preferred that a heat exchanger be placed in the tube transferring light from the Collector to the PBR; such that the temperature of the light or tube is reduced by the heat exchange. It is most preferred that the heat exchanger fluid comprise H₂O.

It is preferred that the O₂ aqueous solution concentration in each PBR is less than 40 percent. It is preferred to reduce the concentration in the CO₂ entering each PBR by diluting the CO₂ with air. It is an embodiment to vent the PBR.

As CO₂ creates carbonic acid in aqueous solution, it is preferred to have a Means of pH control for at least one PBR. It is preferred that the pH in the PBR be between 6 and 10. It is most preferred that the pH in the PBR be between 8 and 9. It is preferred that the aqueous solution comprise at least one of a base and a buffer. It is preferred that the aqueous solution comprises at least one selected from the group consisting of: hydroxide, bi-carbonate, magnesium, and any combination therein. It is preferred that there be a pH meter to measure pH within at least one PBR. It is preferred to have a pH control loop wherein a base is added to the aqueous solution for at least one PBR.

As algae need nutrients to grow, it is preferred that within the PBR aqueous solution is a nutrient concentration. It is preferred that the aqueous solution comprise at least one selected from the group consisting of: PO₄, ammonium, S, Fe, C, and any combination therein. It is most preferred that a unit add to the aqueous solution for at least one PBR at least one nutrient selected from the group consisting of: PO₄, ammonium, S, Fe, C, and any combination therein.

It is preferred to operate a PBR with a reduced concentration of O₂ along with a reduced concentration of S and/or of N₂ in PBR aqueous solution in order for the algae in the aqueous solution to produce H₂ instead of O₂. It is preferred to operate a PBR or a PBR Cluster wherein the concentration of O₂ is reduced and at least one of S and N₂ is reduced enough to facilitate in each PBR the production of H₂ instead of O₂. It is an embodiment to operate at least one PBR in the production of O₂ and at least one PBR in the production of H₂.

As algae growth is best performed with immobilization or agglomeration of the algae, it is an embodiment that the algae within at least one PBR have the ability to adhere to a media within the PBR aqueous solution. It is an embodiment that the media be hydrophobic. It is an embodiment that the media have a density of between 0.7 and 1.3. It is preferred that the media have a density of about 1.0. It is a most preferred an embodiment that the material of the media comprise a material which is resistant to acids. It is a most preferred an embodiment that the material of the media comprise a material which is resistant to bases. It is an embodiment that the material of the media comprise a polymer as is known in the art of polymer science. It is an embodiment that the media have a rough surface for algal adherence.

It is a most preferred embodiment to utilize at least a portion of at least one of the H₂ produced in the PBR(s) and the O₂ produced in the PBR(s) as an energy source for the operation of at least one PBR or at least one PBR Cluster. It is a most preferred embodiment to utilize at least a portion of at least one of the H₂ produced in the PBR(s) and the O₂ produced in the PBR(s) in combustion as an energy source to heat the water entering at least one PBR. It is a most preferred embodiment to utilize at least a portion of at least one of the H₂ produced in the PBR(s) and the O₂ produced in the PBR(s) as an energy source to drive a Generator to generate electricity.

### Denitrifying Bacteria

It is an embodiment that the PBR comprise Means of denitrification, as is known in the art, wherein facultative bacteria, as are known in the art, reduce the NO_{2 or 3} in the aqueous phase to N₂. It is preferred to perform denitrification in the PBR. It is preferred to perform denitrification in a Facultative Biological Reactor (FBR). It is preferred that the Means of denitrification comprise a carbon source for growth of the facultative bacteria. It is most preferred that the COD:N ratio within the denitrification Means be between 6:1 and 3:1. It is an embodiment that the aqueous phase be sent to an anaerobic biological Means comprising sulfite reducing bacteria (“SRB”), as are known in the art, wherein any sulfite, bi-sulfite, sulfate or bi-sulfate within the aqueous phase are reduced to sulfides by the SRB. In the operating scenario wherein anaerobic Means are used to reduce any or either of the sulfite, bi-sulfite, sulfate or bi-sulfate, it is preferred that downstream of the SRB anaerobic Means there be a facultative biological Means comprising sulfur consuming bacteria, to convert at least a portion of any H₂S, SO₂, and SO₃ to elemental sulfur.

It is a preferred embodiment that the aqueous phase be reacted with S consuming bacteria wherein any sulfite, bi-sulfite, sulfate or bi-sulfate within the aqueous phase are reduced to sulfides by the SRB.

It is preferred that the sulfur consuming bacteria comprise Thiobacillus, and most preferred to comprise Thiobacillus denitrificans.

It is most preferred that the sulfur consuming bacteria have a source of carbon.

It is preferred that the algae and/or bacteria comprise at least one of: non-pathogenic, non-opportunistic and low-virulence factor.

It is preferred that the dissolved O₂ content within the aqueous phase of any facultative biological system be about 0.5 ppm O₂ or less. It is most preferred that the dissolved O₂ content within the aqueous phase of any facultative biological system be about 0.3 ppm O₂ or less.

It is most preferred that the carbon source for either denitrification or sulfide consuming bacteria be a form of waste water.

It is an embodiment that the aqueous phase of the FBR perform facultative denitrification of NO²⁻ and NO³⁻. It is most preferred that the denitrification comprise at least one of: the genera selected from the group consisting of: Pseudomonas, Bacillus, and Achromobacter, and any combination therein. It is most preferred that the denitrification be performed with at least one selected from the group consisting of Thiobacillus, such as Thiobacillus denitrificans.

### Sulfur Consuming Bacteria

It is an embodiment that the PBR comprise bacteria that metabolize or consume sulfides and/or sulfur oxides into their biomass. It is a preferred embodiment that the aqueous solution or the liquid comprise at least one selected from the group consisting of: gram-negative bacteria from the beta or gamma subgroup of Proteobacteria, obligate autotrophs, Thioalkalovibrio, strain Al-2, Thioalkalobacter, alkaliphilic heterotrophic bacteria, Pseudomonas strain ChG 3, Rhodococcus erythropolis, Rhodococcus rhodochrous, Rhodococcus sp., Nocardia erythropolis, Nocardia corrolina, other Nocardia sp., Pseudomonas putida, Pseudomonas oleovorans, Pseudomonas species, Arthrobacter globiformis, Arthobacter Nocardia paraffinae, Arthrobacter paraffineus, Arthrobacter citreus, Arthrobacter luteus, other Arthrobacter sp., Mycobacterium vaccae JOB, Mycobacterium Acinetobacter sp., Acinetobacter sp., Corynebacterium sp., Corynebacterium sp., Thiobacillus ferrooxidans, Thiobacillus intermedia, Thiobacillus sp., Shewanella sp., Micrococcus cinneabareus, micrococcus sp., Bacillus sulfasportare, bacillus sp., Fungi, White wood rot fungi, Phanerochaete chrysosporium Phanerochaete sordida, Trametes trogii, Tyromyces palustris, white wood rot fungal sp., Streptomyces fradiae, Streptomyces globisporus, Streptomyces sp., Saccharomyces cerrevisiae, Candida sp., Cryptococcus albidus, yeasts and algae. It is most preferred that the aqueous phase of the FBR comprise at least one species of the genus Thiobacillus and the species therein of Thiobacillus denitrificans.

It is most preferred that the sulfur consuming bacteria comprise at least one of: non-pathogenic, non-opportunistic, low-virulence factor, and any combination therein.

### Separation

It is preferred to perform gas/liquid separation Means, wherein the effluent aqueous solution from the PBR(s) is at least partially separated into a gas and a liquid. It is most preferred that the gas/liquid separation Means comprise cyclone separation. It is preferred that at least a portion of the separated liquid is returned to the aqueous solution in the PBR(s). It is preferred that at least a portion of the separated liquid be further processed for bacterial wasting or for algae harvesting.

It is an embodiment to separate the O₂ from the PBR vent or the separated gas. It is preferred to perform the O₂ separation with at least one selected from the group of: membrane separation, vacuum and/or pressure swing adsorption, cryogenic distillation, and any combination therein. In the case wherein the PBR(s) is producing H₂, it is preferred to separate the H₂ from the PBR vent or the separated gas. It is preferred to perform the H₂ separation with at least one selected from the group of: membrane separation, vacuum and/or pressure swing adsorption, cryogenic distillation, and any combination therein. It is a most preferred embodiment to utilize at least a portion of at least one of the H₂ and the O₂ from the PBR (s) in the combustion of H₂ with O₂; wherein, the combustion comprises an energy source for the operation of at least one PBR. It is a most preferred embodiment to utilize at least a portion of at least one of the H₂ and the O₂ as an energy source to heat the water entering at least one PBR. It is a most preferred embodiment to utilize at least a portion of at least one of the H₂ and the O₂ as an energy source to drive a Generator to power the O₂ separation. It is a most preferred embodiment to utilize at least a portion of at least one of the H₂ and the O₂ as an energy source to drive a Generator to power the operation of at least one PBR.

Liquid/solids separation Means as is known in the art of water treatment is preferred. It is preferred that liquid/solids separation Means comprise one of clarification, thickening, filtration or centrifugation. It is preferred to separate the aqueous solution or the liquid into mostly an aqueous phase and concentrated solids phase, wherein the solids phase comprises algae.

It is most preferred to condition at least one of the bacteria and the algae for liquid/solids separation and/or reducing the liquid concentration in a solids with at least one selected from the group consisting of a: cationic coagulant, quaternized cationic coagulant, cationic polyacrylamide, quaternized polyacrylamide, poly(DADMAC), poly(DADMAC) comprising a molecular weight of at least 1,000,000, poly(epi-DMA), poly(epi-DMA) comprising a molecular weight of at least 500,000, chitosan cationic polymer, quaternized chitosan polymer, starch cationic polymer, quaternized starch polymer, and any combination therein.

### Algae Harvesting

It is preferred to harvest the algae grown in Natural Conversion, which is most preferably the PBR(s). It is preferred to harvest the algae from aqueous solution by liquid/solids separation Means. It is preferred that the harvested algae be used as a protein in food applications or in animal feed. It is preferred that the harvested algae be further processed to obtain a hydrocarbon or hydrocarbon oil(s) from the harvested algae. It is preferred that the harvested algae be used as a fertilizer. It is most preferred that the harvested algae and/or hydrocarbon and/or hydrocarbon oil(s) there from at least partially be used as a combustion fuel. It is preferred that the harvested algae is used as at least one selected from the group consisting of a: protein in food applications, animal feed, hydrocarbon oil(s), combustion, fertilizer, and any combination therein. It is preferred to recycle algae products into Reforming.

### Water Chemistry

H₂O is the most efficient and economical method of storing O₂ and/or H₂. Electrolysis is the most preferred method of converting H₂O into combustible H₂ and O₂. Electrolysis is best performed with a dissolved electrolyte in the H₂O; the dissolved electrolyte, most preferably a salt, will improve conductivity in the H₂O, thereby reducing the required electrical energy to perform electrolysis. It is an embodiment to perform electrolysis upon H₂O that contains an electrolyte. It is preferred to perform electrolysis upon H₂O that contains a salt. It is most preferred to perform electrolysis upon H₂O that contains polyelectrolytes.

Many dissolved cation(s) and anion(s) combination(s) can precipitate over time reducing the efficiency of electrolysis. Further, as temperature is increased, hard H₂O contaminants may precipitate; therefore, it is preferred to add a dispersant to the H₂O to prevent scale.

A dispersant is preferably added to the aqueous solution to prevent scale and/or precipitation on surfaces. Dispersants are low molecular weight polymers, usually organic acids having a molecular weight of less than 25,000 and preferably less than 10,000. Dispersant chemistry is preferably based upon carboxylic chemistry, as well as alkyl sulfate, alkyl sulfite and alkyl sulfide chemistry; it is the oxygen atom that creates the dispersion, wherein oxygen takes its form in the molecule as a carboxylic moiety and/or a sulfoxy moiety. Dispersants preferred which contain the carboxyl moiety include at least one selected from the group consisting of: acrylic polymers, acrylic acid, polymers of acrylic acid, methacrylic acid, maleic acid, fumaric acid, itaconic acid, crotonic acid, cinnamic acid, vinyl benzoic acid, any polymers of these acids and any combination therein. Dispersants that can be used contain the alkyl sulfoxy or allyl sulfoxy moieties include any alkyl or allyl compound, which is water soluble containing a moiety that is at least one of: SO, SO₂, SO₃, SO₄, and/or any combination therein. Due to the many ways in which an organic molecule can be designed to contain the carboxyl moiety and/or the sulfoxy moiety, it is an embodiment that any water soluble organic compound containing at least one of a carboxylic moiety and/or a sulfoxy moiety may be a dispersant in the instant invention. (This is with the knowledge that not all dispersants have equivalent dispersing properties.) Acrylic polymers exhibit very good dispersion properties, thereby limiting the deposition of water soluble salts and are most preferred embodiments as a dispersant. The limitation in the use of a dispersant is in the dispersants water solubility in combination with its carboxylic nature and/or sulfoxy nature.

H₂O is inherently corrosive to metals. H₂O naturally oxidizes metals, some with a greater oxidation rate than others. To minimize corrosion, it is preferred that the H₂O have a pH of equal to or greater than 7.5, wherein the alkalinity of the pH is obtained from the hydroxyl anion. Further, to prevent corrosion or deposition of H₂O deposits on steam turbines, it is preferred to add a corrosion inhibitor to the H₂O. It is an embodiment to utilize nitrogen (N) containing corrosion inhibitors, such as hydrazine, as is known in the art of H₂O treatment.

While corrosion inhibitors are added to H₂O to prevent corrosion, a chelant is preferred to both prevent corrosion and complex, as well as prevent the deposition of, a cation, including hardness and heavy metals. A chelant or a chelating agent is a compound having or forming a heterocyclic ring wherein at least two kinds of atoms are joined in a ring. Chelating is forming a heterocyclic ring compound by joining a chelating agent to a metal ion. Most chelants are polyelectrolytes. It is a preferred embodiment to use a chelant in the H₂O and or the steam to control mineral deposition. It is preferred to add to the H₂O and/or the steam at least one selected from a list consisting of a: phosphate, phosphate polymer, phosphate monomer and any combination thereof. Said phosphate polymers consist of, but are not limited to, phosphoric acid esters, metaphosphates, hexametaphosphates, pyrophosphates and/or any combination thereof Phosphate polymers are particularly effective in dispersing magnesium silicate, magnesium hydroxide and calcium phosphates. Phosphate polymers are particularly effective at corrosion control. With proper selection of a polymer, along with maintaining an adequate polymer concentration level, the surface charge on particle(s) can be favorably altered. In addition to changing the surface charge, polymers also function by distorting crystal growth.

### Apparatus for Manufacturing Plants and Process Flow Paths

It is a preferred embodiment that an apparatus comprising at least one Reformer and at least one Hydrogen Engine form a manufacturing plant and/or process flow path; wherein, the Reformer is upstream of the Hydrogen Engine; wherein, the Reformer has a source of CH₄ or C_{X}H_{y}; wherein the Reformer produces CO₂ and H₂; wherein, H₂ from the Reformer is burned in the Hydrogen Engine; wherein, the Hydrogen Engine comprises a Generator; and wherein, the Generator creates electricity from mechanical energy created in the Hydrogen Engine.

It is a preferred embodiment that an apparatus comprising at least one Reformer and at least one Hydrogen Engine form a process flow path; wherein, the Reformer is upstream of the Hydrogen Engine; wherein, the Reformer has a source of CH₄ or C_{X}H_{Y}; wherein the Reformer produces CO₂ and H₂; wherein, H₂ from the Reformer is burned in the Hydrogen Engine; and wherein, the Hydrogen Engine is used in Transportation.

It is a preferred embodiment that an apparatus comprising at least one Reformer, at least one Hydrogen Engine and at least one PBR form a manufacturing plant and/or process flow path; wherein, the Reformer is upstream of the Hydrogen Engine; wherein the Reformer is upstream of the PBR; wherein the PBR is upstream of the Hydrogen Engine; wherein, the Reformer has a source of CH₄ or C_{X}H_{Y}; wherein the Reformer produces CO₂ and H₂; wherein, the PBR converts CO₂ from the Reformer into O₂; wherein, H₂ from the Reformer and O₂ from the PBR is burned in the Hydrogen Engine; wherein, the Hydrogen Engine comprises a Generator; and wherein, the Generator creates electricity from mechanical energy created in the Hydrogen Engine.

It is a preferred embodiment that an apparatus comprising at least one Reformer, at least one Hydrogen Engine, at least one second Hydrogen Engine, and at least one PBR form a manufacturing plant and/or process flow path; wherein, the Reformer is upstream of the at least one Hydrogen Engine; wherein, the Reformer is upstream of the at least one second Hydrogen Engine; wherein the Reformer is upstream of the PBR; wherein the PBR is upstream of the Hydrogen Engine; wherein, the Reformer has a source of CH₄ or C_{X}H_{Y}; wherein the Reformer produces CO₂ and H₂; wherein, the PBR converts CO₂ from the Reformer into O₂; wherein, H₂ from the Reformer and O₂ from the PBR is burned in the at least one Hydrogen Engine; wherein, the at least one Hydrogen Engine comprises a Generator; wherein, the Generator creates electricity from mechanical energy created in the Hydrogen Engine; wherein, the at least one second Hydrogen Engine burns H₂ from the Reformer; and wherein, the at least one second Hydrogen Engine is used in Transportation.

It is a preferred embodiment that an apparatus comprising at least one Reformer, at least one Hydrogen Engine, at least one source of Light Energy Collection and at least one PBR form a manufacturing plant and/or process flow path; wherein, the Reformer is upstream of the at least one Hydrogen Engine; wherein the Reformer is upstream of the PBR; wherein the PBR is upstream of the Hydrogen Engine; wherein, the source of Light Energy is upstream of the PBR and Hydrogen Engine; wherein, the Reformer has a source of CH₄ or C_{X}H_{Y}; wherein, the Reformer produces CO₂ and H₂; wherein, the PBR converts CO₂ from the Reformer into O₂; wherein, H₂ from the Reformer and O₂ from the PBR is burned in the at least one Hydrogen Engine; wherein alternatively, H₂ and O₂ is obtained by Electrolysis of H₂O and at least a portion of the H₂ and O₂ is burned in the at least one Hydrogen Engine; wherein, the electrical current for Electrolysis of H₂O is from at least one of electricity produced by PV from the Visible portion of said Light Energy Collection or from a Generator driven by said at least one Hydrogen Engine; wherein, the at least one Hydrogen Engine comprises a Generator; wherein, the Generator creates electricity from mechanical energy created in the Hydrogen Engine; wherein, the at least one second Hydrogen Engine burns H₂ from the Reformer; and wherein, the PBR produces algae and O₂.

### EXAMPLE 1

### The Natural Gas Utilization of a Traditional Natural Gas Combustion/Steam System is Compared to That of the Instant Invention

Every g-mole of CH₄ converts to four (4) g-mole of H₂, which equals 232 kcal.

Assume that Sunlight or Wind is used to provide Reformer conversion heat balance; therefore, the entire 232 kcal per g-mole of CH₄ is available as H₂; and,

232 kcal×0.60=139 kcal of electrical energy=0.139 kW·hr (≈0.001 kW·hr/kcal)

In contrast,

CH₄+3O₂→2H₂O+CO₂+213 kcal (today perform ≦35%)

213 kcal×0.35=75 kcal of electrical energy=0.075 kW·hr (≈0.001 kW·hr/kcal)

Therefore, the natural gas is used more efficiently in the instant invention, obtaining a savings in excess of 45% in natural gas usage. (0.139 vs. 0.075)

### EXAMPLE 2

### Comparison of Natural Gas Power Generation per 1000 scf

From the natural gas and power industries, 1000 scf CH₄=1 million BTU and 1 kW·hr=3413 BTU; therefore, the instant invention produces from CH₄:

190 kW·hr per 1000 scf CH₄ (1 million BTU/1000 scf)(1 kWhr/3412 BTU)(0.35)(0.139/0.075)

In contrast, traditional CH₄ systems produce near:

103 kW·hr per 1000 scf CH₄ (1 million BTU/1000 scf)(1 kWhr/3412 BTU)(0.35)

### EXAMPLE 3

### The Efficiency of a Combustion/Steam Turbine Engine (FIG. 16) is Calculated

1500° F. combustion temperature

200° F. water vapor discharge temperature (vacuum).

Carnot Efficiency=[(1500+460)−(200+460)1/(1500+460)=66%.

Leave 6% for friction losses (high and conservative) [symbol] 60% Efficient.

### EXAMPLE 4

### The Energy Efficiency of a Methane Reformer is Calculated

CH₄+H₂O→CO+3H₂−50 kcal

CO+H₂O→CO₂+H₂+18 kcal and in summation

CH₄+2H₂O→CO₂+4H₂−32 kcal this is while

4H₂+2O₂→4H₂O+232 kcal therefore, from an available energy perspective

32 kcal is needed [symbol] 32/232 [symbol] 14% of H₂ is needed to provide heat to reaction, if so used.

### EXAMPLE 5

### Efficiency of the Hydrogen Engine Within a Piston Arrangement is Calculated

Typical piston engine is 15 to 20% efficient.

Combustion Energy=Work+Enthalpy Loss+Entropy Loss+Friction and Combustion Losses

Within hydrocarbon ICE, for every $1.00 spent on fuel, most unfortunately:

$1.00=$0.15+$0.35 (Cooling)+$0.35 (Exhaust)+$0.15

In thermodynamics, cooling losses are termed enthalpy (heat) losses and exhaust losses are termed enthalpy (heat) and entropy (pressure) losses. Therefore, the radiator has enthalpy losses; while, the exhaust has both enthalpy and entropy losses.

First, each cylinder is insulated to capture available energy; therefore, $0.70 or 70% of losses are either trapped in the cylinder walls or forced out the exhaust. Let us have only 90% insulation efficiency. As previous measurements indicate cooling and exhaust losses are about equal, near $0.35 of every $1 or 35% of energy heats the block; while, near $0.35 of every $1 or 35% leaves as exhaust, there is $0.63 or 63%, say only 60%.

The Hydrogen Engine is preferred to operate with 4 cycles; two cycles used for combustion of H₂ and O₂; and two cycles used for Cooling H₂O injection; wherein, an adiabatic system enclosing the cylinder and its layer of insulation; wherein, all as is practical of the cooling energy is transferred into pressure or work, e.g. W=P×V; however, let us only state 60%; therefore, the cooling cycles recover near $0.18 or 18% (0.3×0.6); leaving, the remaining $0.12 or 12% to still leave via the exhaust.

### Energy Recycle:

Given the above, we have near $0.42 or 42% (0.30+0.12) of the combustion energy leaving via the exhaust. For simplicity, let us say $0.40 or 40%.

A steam turbine would be at least 70% efficient.

A electrolysis unit would be at least 70% efficient.

In combination, these units would be at least 0.70×0.70=49% efficient; for simplicity 50%. Therefore, $0.20 or 20% (0.4×0.5) of the combustion energy is recovered.

Final engine efficiency (while an iterative infinite series or integration with e^{x}, for simplicity):

15%+18%+20%=53%; again for simplicity, let us say 50%.

### EXAMPLE 6

In the natural gas industry, scf is @60° F. (=15.6° C.=288.6° K) and 14.7 psia.

1 cubic foot (cf)=0.0283165 cubic meters (m³) and 1 m³=1000 liters (L); so,

1 cf=28.31685 L; and then, 1000 cf=28317 L; therefore,

n=(1 atm)(28317 L)/(0.08206 L atm/mole K)(288.6° K) 1200 moles

Therefore, with Zero Carbon Energy:

1000 scf×1200 mole/1000 scf×0.20 kWhr/mole=240 kWhr/1000 scf CH₄=240 kWhr/Mcf CH4.

While the price of natural gas fluctuates, $15/Mcf is conservative for residential; therefore on a residential basis, $15/Mcf CH_{4×3} k kWhr×Mcf/240 kWhr=$187.50; or, $0.0625/kWhr.

In a commercial setting, the price is <$10/Mcf [symbol] $0.042/kWhr.

In an industrial setting, the price is <$4/Mcf [symbol] $0.017/kWhr.

### EXAMPLE 7

Computer models have been developed to model the instant Hydrogen Engine.

| C.R. | 10 | | | | | | | | | | | | | | | | |
|---|---|---|---|---|---|---|---|---|---|---|---|---|---|---|---|---|---|
| D.S. | 0.069 | L | | | | | | | | | | | | | | | |
| Vo | 0.69 | L | | | | | | | | | | | | | Output | | |
| To | 300 | K | Compression | | | | | Combustion | | | | | | | net- | net- | |
| Ps | n (H2O) | n (H2) | Po | | P1 | | Q | | | P2 | P3 | | W 0-->1 | W 2-->3 | work | work | |
| atm | moles | moles | atm | Y | atm | T1 K | kJ | ΔT K | T2 K | atm | atm | T3 K | l-atm | l-atm | l-atm | kJ | HP |
| 1 | 0.028 | 0.01 | 1.54 | 1.35 | 34.2 | 668 | 2.87 | 2040 | 2709 | 122.5 | 4.9 | 1078 | −4.00 | 12.72 | 8.72 | 0.883 | 178 |
| 1 | 0.028 | 0.02 | 2.07 | 1.36 | 47.6 | 689 | 5.74 | 3231 | 3920 | 224.0 | 8.9 | 1561 | −5.40 | 23.25 | 17.85 | 1.809 | 364 |
| 1 | 0.028 | 0.03 | 2.61 | 1.37 | 61.0 | 702 | 8.61 | 4011 | 4713 | 325.4 | 13.0 | 1876 | −6.80 | 33.78 | 26.98 | 2.733 | 550 |
| 1 | 0.028 | 0.05 | 3.68 | 1.38 | 87.9 | 717 | 14.35 | 4971 | 5688 | 528.0 | 21.0 | 2264 | −9.59 | 54.82 | 45.23 | 4.582 | 921 |
| 2 | 0.056 | 0.01 | 2.54 | 1.34 | 55.1 | 652 | 2.87 | 1175 | 1826 | 143.5 | 5.7 | 727 | −6.61 | 14.90 | 8.29 | 0.839 | 169 |
| 2 | 0.056 | 0.02 | 3.07 | 1.35 | 68.4 | 668 | 5.74 | 2040 | 2709 | 245.1 | 9.8 | 1078 | −8.01 | 25.44 | 17.43 | 1.766 | 355 |
| 2 | 0.056 | 0.03 | 3.61 | 1.36 | 81.8 | 680 | 8.61 | 2705 | 3385 | 346.5 | 13.8 | 1348 | −9.41 | 35.98 | 26.57 | 2.692 | 541 |
| 2 | 0.056 | 0.05 | 4.68 | 1.37 | 108.6 | 696 | 14.35 | 3658 | 4354 | 549.3 | 21.9 | 1733 | −12.20 | 57.04 | 44.84 | 4.542 | 913 |
| 3 | 0.084 | 0.01 | 3.54 | 1.33 | 76.0 | 645 | 2.87 | 825 | 1469 | 164.4 | 6.5 | 585 | −9.22 | 17.07 | 7.85 | 0.795 | 160 |
| 3 | 0.084 | 0.02 | 4.07 | 1.34 | 89.3 | 658 | 5.74 | 1491 | 2149 | 266.0 | 10.6 | 856 | −10.62 | 27.62 | 17.00 | 1.723 | 346 |
| 3 | 0.084 | 0.03 | 4.61 | 1.35 | 102.6 | 668 | 8.61 | 2040 | 2709 | 367.6 | 14.6 | 1078 | −12.01 | 38.16 | 26.15 | 2.649 | 533 |
| 3 | 0.084 | 0.05 | 5.68 | 1.36 | 129.4 | 684 | 14.35 | 2893 | 3577 | 570.5 | 22.7 | 1424 | −14.81 | 59.23 | 44.43 | 4.501 | 905 |

### EXAMPLES 8-10

A molar amount of H₂O, as indicated, is heated to the indicated initial temperature from the heat of the Combustion Chamber to form steam, wherein said heat of the Combustion Chamber is enthalpy from the combustion of H₂ and O₂, wherein the indicated initial temperature and the indicted initial pressure is prior to adiabatic expansion, and wherein: the work performed, the final pressure and the final temperature are after adiabatic expansion of the steam. In the instant invention it is an embodiment to add H₂O to the Combustion Chamber after the combustion of H₂ and O₂ to cool the Combustion Chamber, wherein said H₂O is in the form of a liquid and/or a low pressure gas at a molar ratio of about 1:0.1 to about 1:12 of H₂:H₂O; it is most preferred that said molar ratio be about 1:6 to about 1:10; and, it is most preferred that said molar ratio be 1:8.

Example 8

| | | | | | | | | | |
|---|---|---|---|---|---|---|---|---|---|
| Moles of H₂O | | 0.08 | 0.07 | 0.06 | 0.05 | 0.04 | 0.03 | 0.02 | 0.01 |
| Initial Temp | K | 500 | 500 | 500 | 500 | 500 | 500 | 500 | 500 |
| Initial volume | L | 0.07 | 0.07 | 0.07 | 0.07 | 0.07 | 0.07 | 0.07 | 0.07 |
| Final volume | L | 0.7 | 0.7 | 0.7 | 0.7 | 0.7 | 0.7 | 0.7 | 0.7 |
| Initial pressure | atm | 46.9 | 41.1 | 35.2 | 29.3 | 23.5 | 17.6 | 11.7 | 5.9 |
| Work | L-atm | 4.9 | 4.3 | 3.7 | 3.1 | 2.5 | 1.9 | 1.2 | 0.6 |
| Heat | cal | 860.4 | 752.9 | 645.3 | 537.8 | 430.2 | 322.7 | 215.1 | 107.6 |
| | L-atm | 35.4 | 31.0 | 26.6 | 22.1 | 17.7 | 13.3 | 8.9 | 4.4 |
| Delta T | K | 172.1 | 150.6 | 129.1 | 107.6 | 86.0 | 64.5 | 43.0 | 21.5 |
| Final pressure | atm | 18.68 | 16.34 | 14.01 | 11.67 | 9.34 | 7.00 | 4.67 | 2.33 |
| Final Temp | K | 199 | 199 | 199 | 199 | 199 | 199 | 199 | 199 |

Example 9

| | | | | | | | | | |
|---|---|---|---|---|---|---|---|---|---|
| Moles of H₂O | | 0.08 | 0.07 | 0.06 | 0.05 | 0.04 | 0.03 | 0.02 | 0.01 |
| Initial Temp | K | 773 | 773 | 773 | 773 | 773 | 773 | 773 | 773 |
| Initial volume | L | 0.07 | 0.07 | 0.07 | 0.07 | 0.07 | 0.07 | 0.07 | 0.07 |
| Final volume | L | 0.7 | 0.7 | 0.7 | 0.7 | 0.7 | 0.7 | 0.7 | 0.7 |
| Initial pressure | atm | 72.5 | 63.5 | 54.4 | 45.3 | 36.3 | 27.2 | 18.1 | 9.1 |
| Work | l-atm | 7.6 | 6.7 | 5.7 | 4.8 | 3.8 | 2.9 | 1.9 | 1.0 |
| Heat | cal | 1057.0 | 924.8 | 792.7 | 660.6 | 528.5 | 396.4 | 264.2 | 132.1 |
| | l-atm | 43.5 | 38.1 | 32.6 | 27.2 | 21.7 | 16.3 | 10.9 | 5.4 |
| Delta T | K | 211.4 | 185.0 | 158.5 | 132.1 | 105.7 | 79.3 | 52.8 | 26.4 |
| Final pressure | atm | 28.87 | 25.27 | 21.66 | 18.05 | 14.44 | 10.83 | 7.22 | 3.61 |
| Final Temp | K | 308 | 308 | 308 | 308 | 308 | 308 | 308 | 308 |

Example 10

| | | | | | | | | | |
|---|---|---|---|---|---|---|---|---|---|
| Moles of H₂O | | 0.8 | 0.7 | 0.6 | 0.5 | 0.4 | 0.3 | 0.2 | 0.1 |
| Initial Temp | K | 500 | 500 | 500 | 500 | 500 | 500 | 500 | 500 |
| Initial volume | L | 0.07 | 0.14 | 0.21 | 0.28 | 0.35 | 0.42 | 0.49 | 0.56 |
| Final volume | L | 0.7 | 0.7 | 0.7 | 0.7 | 0.7 | 0.7 | 0.7 | 0.7 |
| Initial pressure | atm | 469.1 | 205.3 | 117.3 | 73.3 | 46.9 | 29.3 | 16.8 | 7.3 |
| Work | L-atm | 49.4 | 34.1 | 23.5 | 15.7 | 9.9 | 5.7 | 2.7 | 0.9 |
| Heat | cal | 8604.0 | 7528.5 | 6453.0 | 5377.5 | 4302.0 | 3226.5 | 2151.0 | 1075.5 |
| | L-atm | 354.1 | 309.8 | 265.6 | 221.3 | 177.0 | 132.8 | 88.5 | 44.3 |
| Delta T | K | 1720.8 | 1505.7 | 1290.6 | 1075.5 | 860.4 | 645.3 | 430.2 | 215.1 |
| Final pressure | atm | 18.68 | 21.56 | 21.74 | 20.32 | 17.78 | 14.34 | 10.17 | 5.36 |
| Final Temp | K | 199 | 263 | 309 | 347 | 379 | 408 | 434 | 457 |

### EXAMPLE 11

Sunlight Available sunlight varies by location, e.g. latitude and weather. For Houston, available sunlight is 4.72 kWhrm⁻² D⁻¹. Sunlight 40% Visible and 60% Infrared. Therefore, daily Visible=1.9 kWhrm⁻² D⁻¹; and daily Infrared=2.8 kWhrm⁻² D⁻¹.

Algae Average Visible per kg of algae produced=12 kWhr/lb for carbohydrates and 16 kWhr/lb for oil.

### Transmission

Reflection—Percent reflection dependent upon mirror coating. Dielectric coating comprising TiO2/SiO2 preferred. Percent reflectance=99%.

Quartz—Fused quartz demonstrates transmittance of =99%.

Water—Water demonstrates visible light transmittance of =99% within =10 cm.

Cable—Optic cable light transmittance=90% per km.

Fresnel loss—Transmission loss from air to silica and silica to air=5%.

Steam—Steam energy losses <20%.

### Light Energy Estimation:

Sun's Visible:

0.99⁵(5 total mirrors)×0.99⁴ (4 total quartz passages)×0.99 (10 cm water passage)×0.95²(2 Fresnel losses)×0.90 (km fiber optic cable)=0.74 70% transmittance; and

1.9 kWhrm⁻²D⁻¹×0.7=1.3 kWhrm⁻²D⁻¹ in 3dPBR.

Sun's IR:

0.95 (Fresnel loss)×0.99³(3 total mirrors)×0.80 (steam transfer)=0.73 70% transmittance; and

2.8 kWm⁻²×0.70=2.0 kWhrm⁻²D⁻¹ in steam energy.

Visible in 3dPBR=1.3 kWhrm⁻²D⁻¹ (39%).

IR & UV in steam energy=2.0 kWhrm⁻²D⁻¹ (61%).

Total Visible, IR & UV=3.3 kWhrm⁻²D⁻¹

Certain objects are set forth above and made apparent from the foregoing description. However, since certain changes may be made in the above description without departing from the scope of the invention, it is intended that all matters contained in the foregoing description shall be interpreted as illustrative only of the principles of the invention and not in a limiting sense. With respect to the above description, it is to be realized that any descriptions, drawings and examples deemed readily apparent and obvious to one skilled in the art and all equivalent relationships to those described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention, it is also to be understood that the following claims are intended to cover all of the generic and specific features of the invention herein described, and all statements of the scope of the invention, which, as a matter of language, might be said to fall in between.

I claim:

1. A method of generating electricity and H₂, wherein
a Reformer produces H₂ and CO₂ from a Hydrocarbon and H₂O, wherein
a PBR produces O₂ from at least one of the CO₂ and carbonate, wherein
Light Energy is separated into Infrared and Visible; wherein
at least a portion of the Visible is transferred to the PBR;
at least a portion of the H₂ and at least a portion of the O₂ is burned in a Combustion Chamber, wherein at least one of
the Combustion Chamber is in a Hydrogen Engine that creates rotating mechanical energy and the Combustion Chamber creates steam that turns a steam turbine that creates rotating mechanical energy, and at least one of
at least a portion of the rotating mechanical energy turns a Generator, such that the Generator creates electricity, and the rotating mechanical energy is used in Transportation.

2. The method of claim 1, wherein at least one of:
H₂O is added to the Combustion Chamber after combustion in a piston engine,
H₂O is added to the Combustion Chamber in a combustion turbine at a point after combustion,
H₂O is added to a Combuster outside of the Combustion Chamber and
H₂O is added to a Combuster inside the Combustion Chamber.

3. The method of claim 2, wherein
at least one of:
the material(s) of construction of said Combustion Chamber comprise a heat capacity capable of storing heat from combustion as enthalpy for the transfer from said Combustion Chamber to said H₂O;
the material(s) of construction of said Combustion Chamber comprise a heat transfer coefficient capable of transferring heat from the previous combustion within the material(s) of said Combustion Chamber to said H₂O;
a combustion cycle is followed by at least one cycle of Energy Recovery Cooling;
combustion comprises a Newsom burn;
at least a portion of at least one of said Combustion Chamber is insulated; and
at least one of said H₂ and said O₂ is added to said Combustion Chamber at a pressure of greater than about 1.0 atmosphere.

4. The method of claim 1, wherein said rotating mechanical energy enters a transmission, wherein
said transmission engages in a manner that is inversely proportional to at least one of the torque and work load on said engine, wherein
said transmission engage a flywheel capable of storing rotational kinetic energy, and wherein
said transmission produce at least a portion of said rotating mechanical energy.

5. The method of claim 1, wherein
At least one of condensate and steam from the steam turbine flow to electrolysis, wherein
at least a portion of said electricity is sent to electrolysis, wherein
H₂O is converted into H₂ and O₂, and wherein
at least a portion of the H₂ and O₂ is used in said Combustion Chamber.

6. The method of claim 1, wherein the PBR(s) comprise at least one selected from the group consisting of:
absorption of CO₂ into aqueous solution,
a number of the PBR(s) arranged side-by-side in a circular pattern forming an ABR Cluster,
a number of annular shaped PBR(s) comprising a tube within a tube, wherein the ABR(s) comprise the annular portion between the radii of outside and the inside tube and the photons enter each ABR from the center tube,
at least one photon tube dispersing photons into each PBR(s),
the PBR(s) aqueous solution comprises contact with photons, wherein the transference of photons to said PBR(s) comprises at least one of a tube and a fiber optic cable,
the PBR(s) comprise insulation,
the PBR(s) comprise a tubular shape comprising a gas tube dispersing the gas into the PBR(s),
the PBR(s) comprise a continuous stirred tank reactor comprising at least one tube dispersing photons into each PBR(s),
the PBR(s) comprise a membrane for dispersing the gas into the ABR(s), and
any combination therein.

7. The method of claim 1, wherein said PBR further comprises a photon tube, wherein
the photon tube comprises at least one of:
a one way mirror at one end, the one way mirror allowing photon entrance into said photon tube while reflecting photons from leaving the same end,
a reflective or mirrored surface at the end opposite the end of photon entrance, and
a fiber optic cable.

8. The method of claim 1, wherein said PBR comprises at least one algae selected from the group consisting of: Anabaena cylindrical, Bostrychia scorpioides, Botrycoccus braunii, Chaetoceros muelleri, Chlamydomonas moeweesi, Chlamydomonas reinhardtii, Chlorella pyrenoidosa, Chlorella vulgaris, Chlorella vulgaris Beij, Dunaliella bioculata, Dunaliella salina, Dunaliella tertiolecta, Euglena gracilis, Isochrysis galbana, Isochrysis galbanais micro, Nannochloris sp., Nannochloropsis salina, Nannochloropsis salina Nannochloris oculata—N. oculata, N. atomus Butcher, N. maculata Butcher, N. gaditaa Lubian, N. oculata, Neochloris oleoabundans, Nitzschia communis, Parietochloris incise, Phaeodactylum tricornutum, Pleurochrysis carterae, haptophyta, prymnesiophyceae, Porphyridium cruentum, Prymnesium parvum, Scenedesmus dimorphus, Scenedesmus obliquus, Scenedesmus quadricauda, Schenedesmus dimorphus, Spirogyra sp., Spirulina maxima, Spirulina platensis, Spirulina sp., Synechoccus sp., Tetraselmis chui, Tetraselmis chui, Tetraselmis maculate, Tetraselmis suecica, Botrycoccus braunii, Botryococcus braunii strains, Chlamydomonas reinhardtii, Chlorella vulgaris, Anabaena cylindrical, Chlamydomonas rheinhardii, Chlorella pyrenoidosa, Chlorella vulgaris, Dunaliella bioculata, Dunaliella salina, Euglena gracilis, Porphyridium cruentum, Prymnesium parvum, Scenedesmus dimorphus, Scenedesmus obliquus, Scenedesmus quadricauda, Spirogyra sp., Spirulina maxima, Spirulina platensis, Synechoccus sp., Tetraselmis maculate, and any combination therein.

9. The method of claim 1, wherein said PBR comprises at least one of denitrifying bacteria and sulfur consuming bacteria.

10. The method of claim 1, wherein said PBR comprises at least one selected from the group consisting of: gram-negative bacteria from the beta or gamma subgroup of Proteobacteria, obligate autotrophs, Thioalkalovibrio, strain LMD 96.55, Thioalkalobacter, alkaliphilic heterotrophic bacteria, Pseudomonas strain ChG 3, Rhodococcus erythropolis, Rhodococcus rhodochrous, Rhodococcus sp., Nocardia erythropolis, Nocardia corrolina, Nocardia sp., Pseudomonas putida, Pseudomonas oleovorans, Pseudomonas sp., Arthrobacter globiformis, Arthobacter Nocardia paraffinae, Arthrobacter paraffineus, Arthrobacter citreus, Arthrobacter luteus, Arthrobacter sp., Mycobacterium vaccae JOB, Mycobacterium sp., Acinetobacter sp., Corynebacterium sp., Thiobacillus ferrooxidans, Thiobacillus intermedia, Thiobacillus Shewanella sp., Micrococcus cinneabareus, Micrococcus sp., Bacillus sulfasportare, bacillus sp., Fungi, White wood rot fungi, Phanerochaete chrysosporium Phanerochaete sordida, Trametes trogii, Tyromyces palustris, white wood rot fungal sp., Streptomyces fradiae, Streptomyces globisporus, Streptomyces sp., Saccharomyces cerrevisiae, Candida sp., Cryptococcus albidus, Algae, sp. of the genus Thiobacillus, such as Thiobacillus denitrificanus, and any combination therein.

11. The method of claim 1, further comprising in said PBR at least one ion selected from the list consisting of phosphate, ammonium, sulfur, iron, carbon and any combination therein.

12. The method of claim 1, further comprising in said PBR at least one selected from the group consisting of: hydroxide, bi-carbonate, magnesium, and any combination therein.

13. The method of claim 1, wherein said PBR comprises at least one selected from the group consisting of: gram-negative bacteria from the beta or gamma subgroup of Proteobacteria, obligate autotrophs, Thioalkalovibrio, strain AL-2, Thioalkalobacter, alkaliphilic heterotrophic bacteria, Pseudomonas strain ChG 3, Rhodococcus erythropolis, Rhodococcus rhodochrous, Rhodococcus sp., Nocardia erythropolis, Nocardia corrolina, other Nocardia sp., Pseudomonas putida, Pseudomonas oleovorans, Pseudomonas sp., Arthrobacter globiformis, Arthobacter Nocardia paraffinae, Arthrobacter paraffineus, Arthrobacter citreus, Arthrobacter luteus, Arthrobacter sp., Mycobacterium vaccae JOB, Mycobacterium sp., Acinetobacter sp., Corynebacterium sp., Thiobacillus ferrooxidans, Thiobacillus intermedia, Thiobacillus Shewanella sp., Micrococcus cinneabareus, Micrococcus sp., Bacillus sulfasportare, bacillus sp., Fungi, White wood rot fungi, Phanerochaete chrysosporium, Phanerochaete sordida, Trametes trogii, Tyromyces palustris, white wood rot fungal sp., Streptomyces fradiae, Streptomyces globisporus, Streptomyces sp., Saccharomyces cerrevisiae, Candida sp., Cryptococcus albidus, Algae, sp. of the genus Thiobacillus, such as Thiobacillus denitrificanus, and any combination therein.

14. The method of claim 1, further comprising at least one of:
a) a Windmill creating rotating mechanical energy, wherein
the rotating mechanical energy turns a Generator, wherein
the Generator creates electricity, wherein
the electricity powers resistor heating, and
the resistor heating provides energy to said Reformer;
b) a Collector gathers Sunlight, wherein
Light Energy travels through a heat exchanger, wherein
Aqueous Solution is heated across the heat exchanger, thereby cooling the Sunlight, and wherein
the Aqueous Solution provides energy to said Reformer; and
c) the H₂ from said Reformer is burned to provide energy to said Reformer.

15. The method of claim 1, wherein
a Collector gathers Sunlight, wherein at least one of:
Light Energy from the Collector travels through at least one of a heat exchanger and a Light Energy Reaction Chamber, wherein
Aqueous Solution is heated by Infrared, wherein at least one of:
the heated Aqueous Solution, as steam, provides energy to said Reformer and flows to a steam turbine to further create at least a portion of said rotating mechanical energy; and wherein
Visible flows to at least one of a PV to create electricity and to said PBR.

16. The method of claim 1, wherein the pressure of said PBR is 1 to 100 atmosphere.

17. The method of claim 15, wherein at least one of:
said Infrared is about greater than 1×10⁻⁶ meter, and
said Visible is about 1×10⁻⁸ meter to about 1×10⁻⁶ meter.

18. The method of claim 15, wherein at least one of:
said Light Energy pass through a translucent material;
said Light Energy pass through a material comprising at least one selected from the list of: Si, quartz, fused quartz, and any combination therein; and
at least a portion of said Light Energy pass through a lens.

19. The method of claim 15, wherein said Aqueous Solution comprises at least one selected from the list consisting of:
a cation and anion pair;
at least one selected of a: group I metal, group II metal, group IVB metal, group VIIB metal, group VIII metal, group IB metal, group IIB metal;
at least one of: Cu, nickel (Ni), iron (Fe), magnesium (Mg), platinum (Pt), titanium (Ti), silver (Ag), gold (Au), zinc (Zn);
at least one of: carbon (C), phosphorous (P), nitrogen (N), silicon (Si), oxygen (O), sulfur (S); and
any combination therein.

20. The method of claim 15, wherein after the Light Energy Reaction Chamber, the temperature of said Aqueous Solution is at least one of:
greater than about 100° C. and less than about 1200° C.;
greater than about 300° C. and less than about 600° C.; and
greater than about 600° C. and less than about 900° C.;

21. The method of claim 20, wherein
At least a portion of the Aqueous Solution converts to steam; wherein
the steam turns a steam turbine, wherein
the steam turbine turns a Generator to create electricity.

22. The method of claim 21, wherein at least a portion of said electricity is used in electrolysis, wherein at least one of
said electrolysis converts H₂O into H₂ and O₂, and
said electrolysis converts H₂O into H₂ and O₂ wherein at least a portion of at least one of the H₂ and the O₂ is used in said Combustion Chamber.

23. The method of claim 1, wherein at least a portion of said rotating mechanical energy powers at least a portion of at least one of:
cryogenic air separation,
membrane air separation,
pressure or vacuum swing absorption air separation; wherein,
at least a portion of the O₂ from air separation burns in said Combustion Chamber.

24. The method of claim 24, wherein N₂ from cryogenic air separation is at least partially used to perform at least one of:
drive a turbine to create rotating mechanical energy wherein at least a portion of the rotating mechanical energy turns a Generator to create electricity for electrolysis.
chill or cool air or H₂O;
chill or cool O₂;
chill or cool H₂;
chill or cool a freon, and
chill or cool CO₂.

25. The method of claim 1, wherein at least one of:
said O₂ and said H₂ is stored in at least one of a cooled gas state and a liquid state; and
said O₂ and said H₂ is stored in at least one of a cooled gas state and a liquid state wherein the compressor(s) for at least one of cooling and/or liquefaction is powered by at least one selected from a list consisting of said rotating mechanical energy and expansion of the cryogenic N₂.
